(19) United States
(12) Patent Application Publication
(10) Pub. No.: US 2025/0327722 A1
(43) Pub. Date: Oct. 23, 2025

(54) SYSTEMS AND METHODS FOR AUTOMATIC STAINING OF SLIDES

(71) Applicants: Radoratory Technologies, Inc., Wilmington, DE (US); Radoratory Technologies PVT Ltd., Telangana (IN)

(72) Inventors: Junaid Shaik, Tirupati (IN); Faisal Ahmed Sheikh, Indore (IN); Harpreet Singh, Telangana (IN); Aravind Kolipaka, DIST-PEDDAPALLI (IN); Srikanth Chary Vadla, Hyderabad (IN)

(73) Assignees: Radoratory Technologies, Inc., Wilmington, DE (US); Radoratory Technologies PVT Ltd., Telangana (IN)

(21) Appl. No.: 19/258,487

(22) Filed: Jul. 2, 2025

Related U.S. Application Data
(63) Continuation of application No. PCT/US2024/010677, filed on Jan. 8, 2024.

(30) Foreign Application Priority Data
Jan. 6, 2023 (IN) 202321001424

(51) Int. Cl. G01N 1/31; G01N 1/30; G01N 35/00; G01N 35/10

(52) U.S. Cl. CPC G01N 1/31; G01N 1/30; G01N 35/00029; G01N 35/1002; G01N 2035/00138

(57) ABSTRACT

Various examples, systems, and methods are disclosed relating to an agentic curation pipeline. One system can process questions and other inquiries about video content by using a combination of models and stored information. The system can receive a query related to an event in a video, selects relevant portions of the video using embeddings, and apply the selected video data and a related sub-query to a video model. The output from the video model can be used by a language model, along with stored context, to generate an answer to the original query. The system can returns the answer to the requester.

### CROSS-REFERENCE TO RELATED APPLICATIONS

The present application is a continuation under 35 U.S.C. § 111(a) of International Application No. PCT/US2024/010677, filed on Jan. 8, 2024, which claims priority to Indian Provisional Patent Application No. 202321001424, filed on Jan. 6, 2023, the entire disclosures of the foregoing applications are incorporated herein by reference.

### FIELD OF DISCLOSURE

The present disclosure relates to automatic staining of slides or specimen placed thereon. In particular, the present disclosure relates to automated systems, apparatuses and methods for treating or processing slides or specimen placed thereon as part of the staining process.

### BACKGROUND

In general, staining is a process of imparting color to cells, tissues or microscopic components present on slides, for highlighting and visualizing the cells, tissues or microscopic components better under a microscope. Staining is carried out with the help of a reagent termed as “stain”. The staining method uses a wide variety of natural and synthetic stains to add color to the colorless specimen. Staining can be done in two ways, namely in-vitro and in-vivo. Currently, a variety of staining methods are known, like simple, differential and special staining. These staining methods are used for various purposes ranging from the study of microscopic organisms to cellular structures, metabolic processes, cytopathology etc.

The protocol of slide preparation generally involves three sequential stages, namely smear preparation, fixation of smear and staining of the specimen. Smear preparation is the first stage and involves mixing of the inoculum with a drop of sterile water and spreading the mixed solution over the glass slide until a thin film is formed on the glass slide. Fixation of smear is the second stage and involves drying and heat fixing the thin microbial layer formed on the glass slide. Staining of the specimen is the final stage where the stain is applied onto the dried smear, which imparts color to the microscopic matter. This procedure is carried out prior to microscopic examination and biochemical tests.

Staining slides is a common technique used in microscopy to visualize and identify cells and other structures in a sample. Staining usually involves adding a buffer solution to the stain applied to the slide or the sample thereon. Buffer solutions are used to neutralize small amounts of acids or bases and maintain the pH level to a certain value or within a fairly narrow range. Most biochemical processes require the pH to remain within a fairly narrow range to proceed normally as excess in acids or bases can interfere with the structure and activity of many biomolecules, especially proteins. Such interference leads to distorted slide examination results.

### SUMMARY

According to one aspect, a system for automatic staining of slides can include a motor; one or more members mechanically coupled to the motor, such that the one or more members when actuated by the motor cause a slide including a sample placed thereon to move along a predefined path; a first nozzle arranged at a first position along the predefined path and configured to release a staining solution on the slide; a second nozzle arranged at a second position along the predefined path and configured to release a buffer solution on the slide; and one or more fans arranged at a third position along the predefined path and configured to circulate air towards the slide and cause mixing of the staining solution and the buffer solution on the slide.

In some implementations, a surface of the slide on which the sample is placed is facing upward. In some implementations, the one or more members can include one or more rods, each rod including a protruding helical structure configured to engage the slide and cause the slide to move along the predefined path. Each rod can include a male thread at one end of the rod, a groove of the male thread structured to receive the slide.

In some implementations, can include one or more support elements extending along the predefined path to support the slide along the predefined path. In some implementations, the system can include an actuator configured to adjust a distance between the first nozzle and the second nozzle along the predefined path. The actuator can include a rack and pinion system mechanically coupled to the second nozzle and configured to cause displacement of the second nozzle to adjust the distance between the first nozzle and the second nozzle along the predefined path.

In some implementations, the system can include a channel structure having one or more outlets and configured to channel air circulated by the one or more fans, via the one or more outlets, towards the staining solution and the buffer solution on the slide.

In some implementations, the system can include one or more sensors configured to detect that a proximity between the slide and at least one of the first nozzle, the second nozzle or the one or more fans satisfies a predefined condition; and an actuator configured to actuate the at least one of the first nozzle, the second nozzle or the one or more fans responsive to detecting that the proximity satisfies the predefined condition.

In some implementations, the system can include a third nozzle arranged at a fourth position along the predefined path and configured to release a washing solution on the slide. The system can include an actuator configured to move the third nozzle across a dimension of the slide while the third nozzle is releasing the washing solution on the slide. The system can include a suction nozzle arranged at a fifth position along the predefined path and configured to remove the washing solution from the slide. The slide is sloped (or inclined) along a portion of the predefined path associated with the third nozzle.

In some implementations, the system can include one or more sweeping members arranged to wipe at least one surface of the slide to remove liquid on the at least one surface. In some implementations, the system can include at least one second fan placed at a fourth position along the predefined path and configured to circulate air to dry liquid on the slide.

In some implementations, the system can include a housing including an opening. The system can include a slide transfer structure having a first end coupled to the opening and configured to receive the slide from the opening, the slide transfer structure having a second end and configured to accommodate a plurality of slides between the first end and the second end. The system can include a cleated belt conveyor configured to receive the slide from the opening, the cleated belt conveyor including a plurality of slots to accommodate a plurality of slides. The cleated belt conveyor can be mechanically coupled to the one or more members through one or more gears. The system can include a container configured to receive the slide from the opening.

According to one aspect, a method for automatic staining of slides can include causing, by a first motion actuator, movement of a slide including a sample placed thereon along a predefined path; automatically actuating a first nozzle arranged at a first position along the predefined path to release a staining solution on the slide responsive to determining that a first actuation condition is satisfied; actuating a second nozzle arranged at a second position along the predefined path to release a buffer solution on the slide responsive to determining that a second actuation condition is satisfied; and actuating, responsive to determining that a third actuation condition is satisfied, one or more fans arranged at a third position along the predefined path to circulate air towards the slide and cause mixing of the staining solution and the buffer solution on the slide.

In some implementations, a surface of the slide on which the sample is placed can be facing upward while the slide moves along the predefined path. In some implementations, the first motion actuator can include a motor, and one or more members mechanically coupled to the motor. The one or more members when actuated by the motor cause the slide to move along the predefined path. The one or more members can include one or more rods. Each rod can include a protruding helical structure configured to engage the slide and cause the slide to move along the predefined path. Each rod can include a male thread at one end of the rod, a groove of the male thread structured to receive the slide.

In some implementations, one or more support elements extending along the predefined path support the slide along the predefined path. In some implementations, the method can include adjusting, by a second motion actuator, a distance between the first nozzle and the second nozzle along the predefined path. The second motion actuator can include a rack and pinion system mechanically coupled to the second nozzle and the method can include causing, by the rack and pinion system, displacement of the second nozzle to adjust the distance between the first nozzle and the second nozzle along the predefined path. The method can include channeling, by a channel structure having one or more outlets, air circulated by the one or more fans through the one or more outlets towards the staining solution and the buffer solution on the slide.

In some implementations, the method can include detecting, by a sensor, that the slide is beneath the first nozzle; and actuating the first nozzle to release the staining solution on the slide responsive to detecting that the slide is beneath the first nozzle.

In some implementations, the method can include detecting, by a sensor, that a proximity between the slide and the one or more fans satisfies a predefined condition; and actuating the one or more fans to circulate air responsive to detecting that the proximity between the slide and the one or more fans satisfies the predefined condition.

In some implementations, the method can include actuating a third nozzle arranged at a fourth position along the predefined path to release a washing solution on the slide. The method can include causing, by a second motion actuator, movement of the third nozzle across a dimension of the slide while the third nozzle is releasing the washing solution on the slide. The method can include removing, at least partially, by a suction nozzle arranged at a fifth position along the predefined path, the washing solution from the slide. The slide can be sloped (or inclined) along a portion of the predefined path associated with the third nozzle.

In some implementations, the method can include wiping, by one or more sweeping members, at least one surface of the slide to remove liquid on the at least one surface. In some implementations, the method can include actuating at least one second fan placed at a fourth position along the predefined path to circulate air and dry liquid on the slide.

In some implementations, the method can include providing a slide transfer structure to receive stained slides, the slide transfer structure configured to accommodate a plurality of slides. In some implementations, the method can include providing a cleated belt conveyor configured to receive stained slides, the cleated belt conveyor including a plurality of slots to accommodate a plurality of slides. The method can include synchronizing motion of the cleated belt conveyor with motion of the one or more members through one or more gears mechanically coupling the cleated belt conveyor to the one or more members. In some implementations, the method can include providing a container configured to receive stained slides.

According to one aspect, a system for mixing solutions on slides can include one or more support elements structured to support a slide containing a sample placed thereon; one or more fans; and a motion actuator coupled to either the slide or the one or more fans and configured to cause relative movement between the slide and the one or more fans. The one or more fans can be configured to circulate air to spread the at least one solution on the slide responsive to the relative movement between the slide and the one or more fans.

In some implementations, the system can include a user interface for controlling the speed and direction of the one or more fans and the speed of the relative movement between the slide and the one or more fans.

In some implementations, the relative movement includes the slide moving beneath the one or more fans or the one or more fans moving above the slide.

In some implementations, the system can include a motor mechanically coupled to the motion component for driving the relative movement between the slide and the one or more fans. In some implementations, the system can include a sensor for detecting a relative proximity between the slide and the one or more fans.

In some implementations, the system can include a processor coupled to the sensor and the one or more fans, the processor configured to cause the one or more fans to start responsive to the sensor detecting the relative proximity between the slide and the one or more fans. In some implementations, the system can include a processor configured to control the relative movement between the slide and the one or more fans.

In some implementations, the one or more fans can include a pair of fans rotating in a same direction. In some implementations, the one or more fans can include a pair of fans rotating in opposite directions. In some implementations, the set of rails can be made of stainless steel or plastic.

In some implementations, the slide contains two or more solutions placed thereon, the air circulated by the fan causing the two or more solutions on the slide to be mixed with one another responsive to the relative movement between the slide and the one or more fans.

In some implementations, the one or more fans are mounted above the rails and are positioned such that the slide is positioned beneath the one or more fans with a small distance between the slide and the one or more fans.

According to one aspect, a method for automatic staining of slides can include causing a relative movement between a slide positioned on a set of rails and one or more fans; determining that a relative proximity between the slide and the one or more fans satisfies a condition; and actuating, responsive to determining that the relative proximity between the slide and the one or more fans satisfies the condition, the one or more fans to cause a solution on the slide to spread over the slide.

In some implementations, causing the relative movement can include causing the slide to move beneath the one or more fans or causing the one or more fans to move above the slide. In some implementations, the method can include driving, by a motor, the relative movement between the slide and the one or more fans.

In some implementations, determining that the relative proximity between the slide and the one or more fans satisfies the condition can include detecting, using a sensor, a position of the slide or the one or more fans.

According to one aspect, a method for mixing solutions on slides can include providing a set of rails to receive a slide; actuating a motion component to cause the slide to move on the set of rails, the motion component mechanically engaging the slide; providing one or more fans proximate to the set of rails; and actuating the one or more fans to circulate air, the circulating air causing a stain and a buffer solution place on the slide to be mixed upon the slide moving, on the set of rails, within proximity to the one or more fans.

According to one aspect, a system for washing stained slides in preparation for pathology testing can include a set of rails configured to carry a stained slide containing at least one solution; a channeling structure configured to channel a buffer solution onto the stained slide; a motion component configured to cause relative movement between the stained slide and the channeling structure; and one or more processors configured to determine that a relative proximity between the stained slide and the channeling structure satisfies a condition using a sensor, and cause the buffer solution to flow through the channeling structure onto the stained slide responsive to determining that the relative proximity between the stained slide and the channeling structure satisfies the condition.

In some implementations, the channeling structure can include an inlet port and one or more outlet ports. The system can include a pump connected to the inlet port and configured to pump the buffer solution into the channeling structure via the inlet port. The one or more processors can be configured to actuate the pump responsive to determining that the relative proximity between the stained slide and the channeling structure satisfies the condition. The buffer solution can cause excess of the at least one solution to be removed from the slide.

In some implementations, the relative movement between the stained slide and the channeling structure can include the slide moving beneath the channeling structure or the channeling structure moving above the slide.

According to one aspect, a method for washing stained slides can include providing a set of rails to carry a stained slide containing at least one solution thereon; providing a channeling structure to channel a buffer solution onto the stained slide; providing a motion component to cause relative movement between the stained slide and the channeling structure; determining that a relative proximity between the stained slide and the channeling structure satisfies a condition using a sensor; and causing the buffer solution to flow through the channeling structure onto the stained slide responsive to determining that the relative proximity between the stained slide and the channeling structure satisfies the condition.

In some aspects, the techniques described herein relate to a system for automatic staining of slides, the system including: a motor; one or more members mechanically coupled to the motor, the one or more members when actuated by the motor cause a slide including a sample placed thereon to move along a predefined path; a first nozzle arranged at a first position along the predefined path and configured to release a staining solution on the slide; a second nozzle arranged at a second position along the predefined path and configured to release a buffer solution on the slide; and one or more fans arranged at a third position along the predefined path and configured to circulate air towards the slide and cause mixing of the staining solution and the buffer solution on the slide.

In some aspects, the techniques described herein relate to a system, wherein a surface of the slide on which the sample is placed is facing upward.

In some aspects, the techniques described herein relate to a system, wherein the one or more members include one or more rods, each rod including a protruding helical structure configured to engage the slide and cause the slide to move along the predefined path.

In some aspects, the techniques described herein relate to a system, wherein each rod includes a male thread at one end of the rod, a groove of the male thread structured to receive the slide.

In some aspects, the techniques described herein relate to a system, including one or more support elements extending along the predefined path to support the slide along the predefined path.

In some aspects, the techniques described herein relate to a system, further including an actuator configured to adjust a distance between the first nozzle and the second nozzle along the predefined path.

In some aspects, the techniques described herein relate to a system, wherein the actuator includes a rack and pinion system mechanically coupled to the second nozzle and configured to cause displacement of the second nozzle to adjust the distance between the first nozzle and the second nozzle along the predefined path.

In some aspects, the techniques described herein relate to a system, further including a channel structure having one or more outlets and configured to channel air circulated by the one or more fans, via the one or more outlets, towards the staining solution and the buffer solution on the slide.

In some aspects, the techniques described herein relate to a system, further including: one or more sensors configured to detect that a proximity between the slide and at least one of the first nozzle, the second nozzle or the one or more fans satisfies a predefined condition; and an actuator configured to actuate the at least one of the first nozzle, the second nozzle or the one or more fans responsive to detecting that the proximity satisfies the predefined condition.

In some aspects, the techniques described herein relate to a system, further including a third nozzle arranged at a fourth position along the predefined path and configured to release a washing solution on the slide.

In some aspects, the techniques described herein relate to a system, further including an actuator configured to move the third nozzle across a dimension of the slide while the third nozzle is releasing the washing solution on the slide.

In some aspects, the techniques described herein relate to a system, further including a suction nozzle arranged at a fifth position along the predefined path and configured to remove the washing solution from the slide.

In some aspects, the techniques described herein relate to a system, wherein the slide is sloped along a portion of the predefined path associated with the third nozzle.

In some aspects, the techniques described herein relate to a system, further including one or more sweeping members arranged to wipe at least one surface of the slide to remove liquid on the at least one surface.

In some aspects, the techniques described herein relate to a system, further including at least one second fan placed at a fourth position along the predefined path and configured to circulate air to dry liquid on the slide.

In some aspects, the techniques described herein relate to a system, further including a housing including an opening.

In some aspects, the techniques described herein relate to a system, further including a slide transfer structure having a first end coupled to the opening and configured to receive the slide from the opening, the slide transfer structure having a second end and configured to accommodate a plurality of slides between the first end and the second end.

In some aspects, the techniques described herein relate to a system, further including a cleated belt conveyor configured to receive the slide from the opening, the cleated belt conveyor including a plurality of slots to accommodate a plurality of slides.

In some aspects, the techniques described herein relate to a system, wherein the cleated belt conveyor is mechanically coupled to the one or more members through one or more gears.

In some aspects, the techniques described herein relate to a system, further including a container configured to receive the slide from the opening.

In some aspects, the techniques described herein relate to a method for automatic staining of slides, the method including: causing, by a first motion actuator, movement of a slide including a sample placed thereon along a predefined path; automatically actuating a first nozzle arranged at a first position along the predefined path to release a staining solution on the slide responsive to determining that a first actuation condition is satisfied; actuating a second nozzle arranged at a second position along the predefined path to release a buffer solution on the slide responsive to determining that a second actuation condition is satisfied; and actuating, responsive to determining that a third actuation condition is satisfied, one or more fans arranged at a third position along the predefined path to circulate air towards the slide and cause mixing of the staining solution and the buffer solution on the slide.

In some aspects, the techniques described herein relate to a method, wherein a surface of the slide on which the sample is placed is facing upward while the slide moves along the predefined path.

In some aspects, the techniques described herein relate to a method, wherein the first motion actuator includes: a motor; and one or more members mechanically coupled to the motor, the one or more members when actuated by the motor cause the slide to move along the predefined path.

In some aspects, the techniques described herein relate to a method, wherein the one or more members include one or more rods, each rod including a protruding helical structure configured to engage the slide and cause the slide to move along the predefined path.

In some aspects, the techniques described herein relate to a system, wherein each rod includes a male thread at one end of the rod, a groove of the male thread structured to receive the slide

In some aspects, the techniques described herein relate to a method, wherein one or more support elements extending along the predefined path support the slide along the predefined path.

In some aspects, the techniques described herein relate to a method, further including adjusting, by a second motion actuator, a distance between the first nozzle and the second nozzle along the predefined path.

In some aspects, the techniques described herein relate to a method, wherein the second motion actuator includes a rack and pinion system mechanically coupled to the second nozzle, the method including causing, by the rack and pinion system, displacement of the second nozzle to adjust the distance between the first nozzle and the second nozzle along the predefined path.

In some aspects, the techniques described herein relate to a method, further including channeling, by a channel structure having one or more outlets, air circulated by the one or more fans through the one or more outlets towards the staining solution and the buffer solution on the slide.

In some aspects, the techniques described herein relate to a method, including detecting, by a sensor, that the slide is beneath the first nozzle; and actuating the first nozzle to release the staining solution on the slide responsive to detecting that the slide is beneath the first nozzle.

In some aspects, the techniques described herein relate to a method, including detecting, by a sensor, that a proximity between the slide and the one or more fans satisfies a predefined condition; and actuating the one or more fans to circulate air responsive to detecting that the proximity between the slide and the one or more fans satisfies the predefined condition.

In some aspects, the techniques described herein relate to a method, further including actuating a third nozzle arranged at a fourth position along the predefined path to release a washing solution on the slide.

In some aspects, the techniques described herein relate to a method, further including causing, by a second motion actuator, movement of the third nozzle across a dimension of the slide while the third nozzle is releasing the washing solution on the slide.

In some aspects, the techniques described herein relate to a method, further including removing, at least partially, by a suction nozzle arranged at a fifth position along the predefined path, the washing solution from the slide.

In some aspects, the techniques described herein relate to a system, wherein the slide is sloped along a portion of the predefined path associated with the third nozzle.

In some aspects, the techniques described herein relate to a method, further including wiping, by one or more sweeping members, at least one surface of the slide to remove liquid on the at least one surface.

In some aspects, the techniques described herein relate to a system, further including actuating at least one second fan placed at a fourth position along the predefined path to circulate air and dry liquid on the slide.

In some aspects, the techniques described herein relate to a method, further including providing a slide transfer structure to receive stained slides, the slide transfer structure configured to accommodate a plurality of slides.

In some aspects, the techniques described herein relate to a method, further including providing a cleated belt conveyor configured to receive stained slides, the cleated belt conveyor including a plurality of slots to accommodate a plurality of slides.

In some aspects, the techniques described herein relate to a method, including synchronizing motion of the cleated belt conveyor with motion of the one or more members through one or more gears mechanically coupling the cleated belt conveyor to the one or more members.

In some aspects, the techniques described herein relate to a system, further including providing a container configured to receive stained slides.

In some aspects, the techniques described herein relate to a system, including: one or more support elements structured to support a slide containing a sample placed thereon; one or more fans; and a motion actuator coupled to either the slide or the one or more fans and configured to cause relative movement between the slide and the one or more fans, the one or more fans configured to circulate air to spread the at least one solution on the slide responsive to the relative movement between the slide and the one or more fans.

In some aspects, the techniques described herein relate to a system, further including a user interface for controlling the speed and direction of the one or more fans and the speed of the relative movement between the slide and the one or more fans.

In some aspects, the techniques described herein relate to a system, wherein the relative movement includes the slide moving beneath the one or more fans or the one or more fans moving above the slide.

In some aspects, the techniques described herein relate to a system, further including a motor mechanically coupled to the motion component for driving the relative movement between the slide and the one or more fans.

In some aspects, the techniques described herein relate to a system, further including a sensor for detecting a relative proximity between the slide and the one or more fans.

In some aspects, the techniques described herein relate to a system, further including a processor coupled to the sensor and the one or more fans, the processor configured to cause the one or more fans to start responsive to the sensor detecting the relative proximity between the slide and the one or more fans.

In some aspects, the techniques described herein relate to a system, including a processor configured to control the relative movement between the slide and the one or more fans.

In some aspects, the techniques described herein relate to a system, wherein the one or more fans include a pair of fans rotating in a same direction.

In some aspects, the techniques described herein relate to a system, wherein the one or more fans include a pair of fans rotate in opposite directions.

In some aspects, the techniques described herein relate to a system, wherein the set of rails are made of stainless steel or plastic.

In some aspects, the techniques described herein relate to a system, wherein the slide contains two or more solutions placed thereon, the air circulated by the fan causing the two or more solutions on the slide to be mixed with one another responsive to the relative movement between the slide and the one or more fans.

In some aspects, the techniques described herein relate to a system, wherein the one or more fans are mounted above the rails and are positioned such that the slide is positioned beneath the one or more fans with a small distance between the slide and the one or more fans.

In some aspects, the techniques described herein relate to a method, including: causing a relative movement between a slide positioned on a set of rails and one or more fans; determining that a relative proximity between the slide and the one or more fans satisfies a condition; and actuating, responsive to determining that the relative proximity between the slide and the one or more fans satisfies the condition, the one or more fans to cause a solution on the slide to spread over the slide.

In some aspects, the techniques described herein relate to a method, wherein causing the relative movement includes causing the slide to move beneath the one or more fans or causing the one or more fans to move above the slide.

In some aspects, the techniques described herein relate to a method, including driving, by a motor, the relative movement between the slide and the one or more fans.

In some aspects, the techniques described herein relate to a method, wherein determining that the relative proximity between the slide and the one or more fans satisfies the condition includes detecting, using a sensor, a position of the slide or the one or more fans.

In some aspects, the techniques described herein relate to a method for mixing stain and buffer solutions for staining slides, the method including: providing a set of rails to receive a slide; actuating a motion component to cause the slide to move on the set of rails, the motion component mechanically engaging the slide; providing one or more fans proximate to the set of rails; and actuating the one or more fans to circulate air, the circulating air causing a stain and a buffer solution place on the slide to be mixed upon the slide moving, on the set of rails, within proximity to the one or more fans.

In some aspects, the techniques described herein relate to a system for washing stained slides in preparation for pathology testing, the system including: a set of rails configured to carry a stained slide containing at least one solution; a channeling structure configured to channel a buffer solution onto the stained slide; a motion component configured to cause relative movement between the stained slide and the channeling structure; and one or more processors configured to: determine that a relative proximity between the stained slide and the channeling structure satisfies a condition using a sensor; and cause the buffer solution to flow through the channeling structure onto the stained slide responsive to determining that the relative proximity between the stained slide and the channeling structure satisfies the condition.

In some aspects, the techniques described herein relate to a system, wherein the channeling structure includes an inlet port and one or more outlet ports, the system further including: a buffer solution pump connected to the inlet port and configured to pump the buffer solution into the channeling structure via the inlet port, the one or more processors configured to actuate the buffer solution pump responsive to determining that the relative proximity between the stained slide and the channeling structure satisfies the condition.

In some aspects, the techniques described herein relate to a system, wherein the buffer solution causes excess of the at least one solution to be removed from the slide.

In some aspects, the techniques described herein relate to a system, wherein the relative movement between the stained slide and the channeling structure includes the slide moving beneath the channeling structure or the channeling structure moving above the slide.

In some aspects, the techniques described herein relate to a method for washing stained slides in preparation for pathology testing, the method including: providing a set of rails to carry a stained slide containing at least one solution thereon; providing a channeling structure to channel a buffer solution onto the stained slide; providing a motion component to cause relative movement between the stained slide and the channeling structure; determining that a relative proximity between the stained slide and the channeling structure satisfies a condition using a sensor; and causing the buffer solution to flow through the channeling structure onto the stained slide responsive to determining that the relative proximity between the stained slide and the channeling structure satisfies the condition.

### BRIEF DESCRIPTION OF THE DRAWINGS

FIGS. 1A-1D depict perspective views of a staining device (or staining system) for automatically staining slides, according to an embodiment of the current disclosure.

FIGS. 2A-2D depict interior views of the staining device (or staining system) of FIGS. 1A-1C, according to an embodiment of the current disclosure.

FIG. 3 depicts a flow chart of a method for automatically staining of slides, according to an embodiment of the current disclosure.

FIG. 4A-4C show various aspects of the slide transport system shown in FIGS. 2A and 2B, according to an example embodiment of the current disclosure.

FIGS. 5A-5C depict different views of a system for automatically releasing staining solution on slides, according to an embodiment of the current disclosure.

FIGS. 6A-6C depict a buffering system for automatically releasing buffer solution on slides, according to an embodiment of the current disclosure.

FIG. 7 is a flow chart illustrating a method for automatically releasing a solution on slides, according to an embodiment of the current disclosure.

FIGS. 8A-8H depict different views of a system for automatically mixing solutions on slides, according to an embodiment of the current disclosure.

FIG. 9 is a flow chart illustrating a method for automatic mixing of solutions on slides, according to an embodiment of the current disclosure.

FIGS. 10A-10E depict various views of a system for automatic washing of slides, according to an example embodiment of the current disclosure.

FIGS. 10F-10N depict other systems and devices for automatic washing of slides, according to an example embodiment of the current disclosure.

FIG. 10O depicts orientation of slides during a washing process, according to an example embodiment of the current disclosure.

FIG. 11 is a flow chart illustrating a method of automatic the washing of slides, according to an embodiment of the current disclosure.

FIGS. 12A-12E depict various views of a system for wiping slides, according to an embodiment of the current disclosure.

FIGS. 13A-13E depict various views of a system for automatic drying of slides, according to an embodiment of the current disclosure.

FIG. 14A-14B depicts a collection box for receiving stained slides output by the staining device, according to an embodiment of the current disclosure.

FIG. 15A-15D depicts a conveyor system for receiving stained slides output by the staining device, according to an embodiment of the current disclosure.

FIG. 16A-16B depicts a slide transfer system for receiving stained slides output by the staining device, according to an embodiment of the current disclosure.

### DETAILED DESCRIPTION

Following below are more detailed descriptions of various concepts related to, and implementations of, methods, apparatuses, and systems for automatic staining of slides. The various concepts introduced above and discussed in greater detail below may be implemented in any of numerous ways as the described concepts are not limited to any particular manner of implementation. Specific implementations and applications are provided primarily for illustrative purposes.

The staining process, in general, includes a plurality of steps. A first step, referred to as staining, involves placing a stain solution on a dried smear slide and waiting for a certain duration as per a recommended staining procedure. A second step, referred to as buffering, involves adding a buffer solution to stained slide. A third step, referred to as mixing, involves mixing the stain and the buffer solution. The mixing allows the buffer solution to reach any amounts of acids or bases and neutralize them. A fourth step, referred to as incubation, involves waiting for a certain amount of time as per the type of stain procedure being followed. A fifth step, referred to as washing, involves washing the stain and buffer mixture solution with the same buffer solution or other buffer solution. Finally, a sixth step, referred to as drying, involves, drying the slide after the washing step and before the slide is used for study under a microscope.

Traditionally, the above-described steps of the staining process are performed manually by a pathologist or a pathology technician. The manual staining is slow and time consuming. As such, the manual staining contributes to the building of a backlog of pathology tests at any given point in time. Also, the manual staining process including manual placing of the stain and buffer solutions on the slide, the manual mixing of these solutions and/or the manual washing of the slide can lead to inconsistencies and variations in the quality of the staining, for example, due to non-homogeneous distribution of the stain or the buffer solution over the slide or specimen.

The above discussed problems associated with manual staining call for automated and more reliable staining systems and processes to speed up the staining process, reduce cost, improve staining quality, reduce examination errors and increase throughput (e.g., in terms of the number of slides stained per a unit of time). According to embodiments described herein, an automated slide staining device (or slide staining system) and automated slide staining process allow for automatically performing the above-described steps or any combination thereof. The staining process comprising the steps discussed above, or a combination thereof can be performed by a device referred to herein as stainer device or stainer apparatus. The input to the stainer device can be a slide with dried smear placed thereon, and the output of the device is a stained slide which is ready to be studied under a microscope.

In the following, embodiments of an automated staining device and components thereof are described. Also, the automated staining process is described in relation with the automated staining system. The automated staining system and process allow for faster, more efficient and more accurate staining.

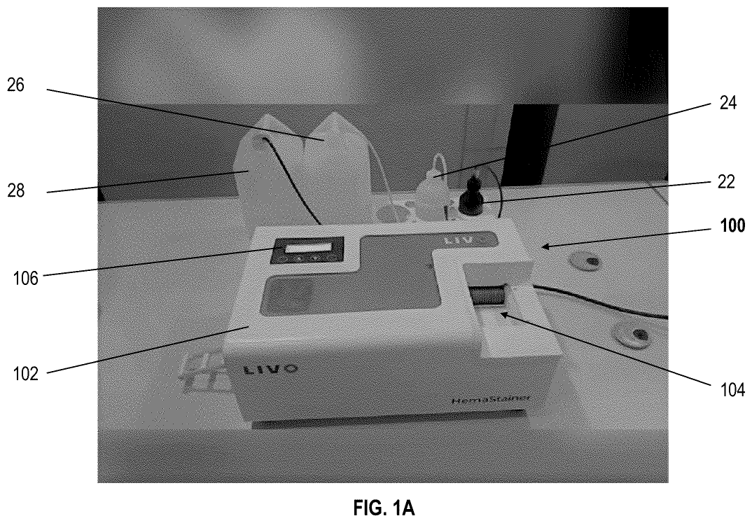

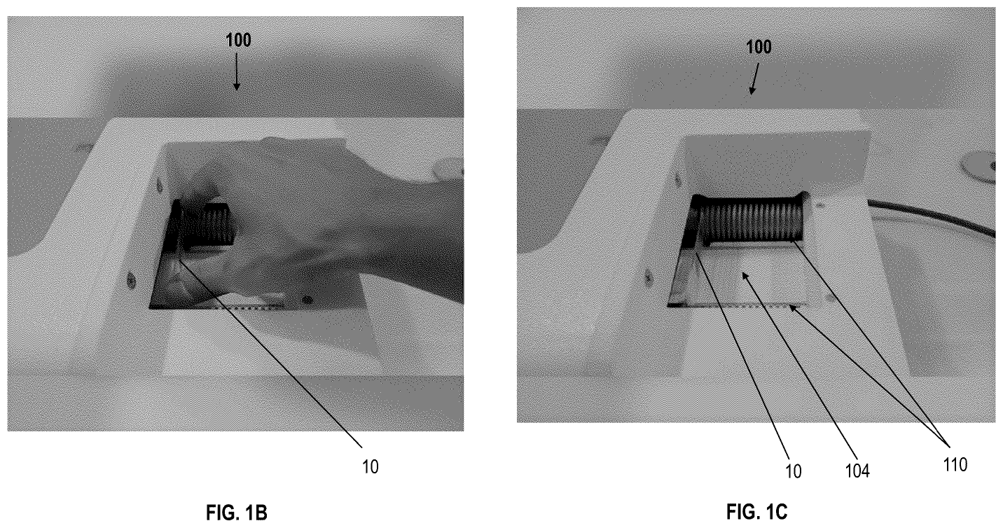

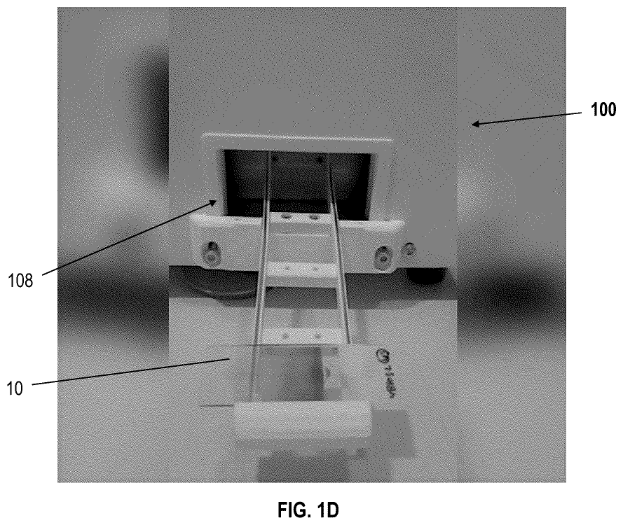

Referring now to FIGS. 1A-1D, perspective views of staining device (or staining system) 100 for automatically staining slides are depicted, according to an embodiment of the current disclosure. In brief overview, the staining device 100 can include a housing 102 having a first opening 104 for receiving slides 10. The staining device 100 or the housing 102 can include an interface 106 to enable an operator to interact with the staining device 100. The staining device 100 can include or can be coupled to a plurality of fluid containers, such as containers 22, 24 and 26a-26b.

The housing 102 can enclose or house the internal components of the staining device 100. The housing 102 can provide protection to the internal components of the staining device 100 and/or slides 10 being processed or treated in the staining device 100. FIGS. 1A-1C depict an example design of the housing 102, which is not to be construed as limiting. In some implementations, the housing 102 can be implemented according to a different design, different shape and/or different size. For example, the housing 102 may be fully or partially transparent.

The housing 102 can include a first opening 104 for receiving slides 10. The opening 104 can be structured or designed to expose a portion of a slide transport system 110 configured or structured to carry slides 10 along a predefined path. As depicted in FIG. 1B, an operator can place a slide 10, e.g., vertically, on the portion of the slide transport system 110 exposed by the opening 104. The operator can place the slide such that the surface of the slide 10 on which the sample, specimen or smear is placed is facing opposite to the direction in which the slide 10 is to move when placed on the slide transport system 110. The slide 10 can be placed on one of its lengthwise edges. In some implementations, the operator can place the slide 10 while the slide transport system 110 is in motion.

The interface 106 can include control panel with buttons, indicator lights and/or a display. The interface, e.g., via the buttons, can enable the operator to start the staining device 100 and/or set parameters of the staining process. The display can be configured to render information related to the staining device 100 and/or the staining process. In some implementations, the interface 106 can include touch screen enabling interaction with the staining device 100. In some implementations, the staining device 100 can be communicatively coupled to one or more computing devices and the operator can interact with the staining device 100 through the one or more computing devices.

The staining device 100 can include or can be coupled to a plurality of fluid containers, such as containers 22, 24, 26 and 28. For example, container 22 can include a stain or staining solution for staining slides 10. Container 22 can be coupled to the staining device 100 or component thereof via a corresponding tube. Container 24 can include a buffer solution to be mixed with the staining solution on the slides 10. Container 24 can be coupled to the staining device 100 or a component thereof via a corresponding tube. Container 26 can carry or can include a washing solution for washing the slides 10. The container 26 can be coupled to the staining device 100 or a component thereof via a corresponding tube. Container 28 can be a drainage container configured to receive solution drained from the staining device 100. The container 28 can be coupled to the staining device 100 or a component thereof via a corresponding tube.

The slide 10 can include a sample or specimen placed thereon. For example, the slide 10 can include a smear, e.g., a blood smear, placed thereon. While the description herein focuses mainly on the automatic staining of slides 10, it is to be understood that the systems and methods describes herein can also be applicable to other slide treatment processes, other medical devices/systems and/or other automated systems.

The term slide, as used herein, can refer to a thin, flat piece of glass or other transparent material, typically rectangular in shape, which is utilized for the examination and analysis of samples in laboratory settings. One function of the slide is to support a smear, a thinly spread layer, of a biological, chemical, or material sample for microscopic examination or other analytical procedures. The sample smear is prepared by spreading a small amount of the sample across the surface of the slide in a controlled, uniform manner, thereby creating a layer thin enough to allow light or other imaging techniques to pass through for detailed observation and analysis. The slide is designed to be compatible with various laboratory instruments, including but not limited to microscopes, staining devices, and automated handling equipment. Its dimensions, thickness, and material composition are standardized to ensure consistent handling, processing, and image clarity. Furthermore, the surface of the slide may undergo specific treatments to enhance sample adhesion, improve optical properties, or facilitate specific types of analytical tests.

The staining device 100 can include a second opening 108, as depicted in FIG. 1C, for outputting processed or stained slides 10. As will be describe in further detail below, various mechanisms can be used for receiving or collecting processed slides 10.

The term slide, as used herein, can refer to a thin, flat piece of glass or other transparent material, typically rectangular in shape, which is utilized for the examination and analysis of samples in laboratory settings. One function of the slide is to support a smear, a thinly spread layer, of a biological, chemical, or material sample for microscopic examination or other analytical procedures. The sample smear is prepared by spreading a small amount of the sample across the surface of the slide in a controlled, uniform manner, thereby creating a layer thin enough to allow light or other imaging techniques to pass through for detailed observation and analysis. The slide is designed to be compatible with various laboratory instruments, including but not limited to microscopes, staining devices, and automated handling equipment. Its dimensions, thickness, and material composition are standardized to ensure consistent handling, processing, and image clarity. Furthermore, the surface of the slide may undergo specific treatments to enhance sample adhesion, improve optical properties, or facilitate specific types of analytical tests.

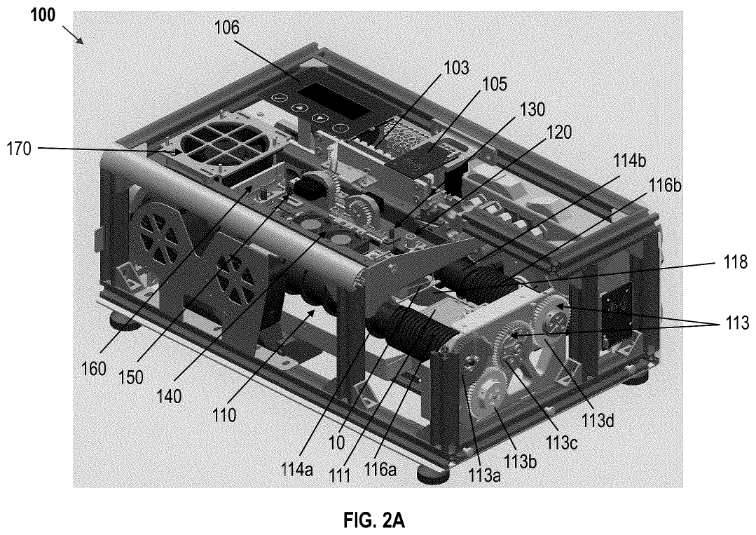

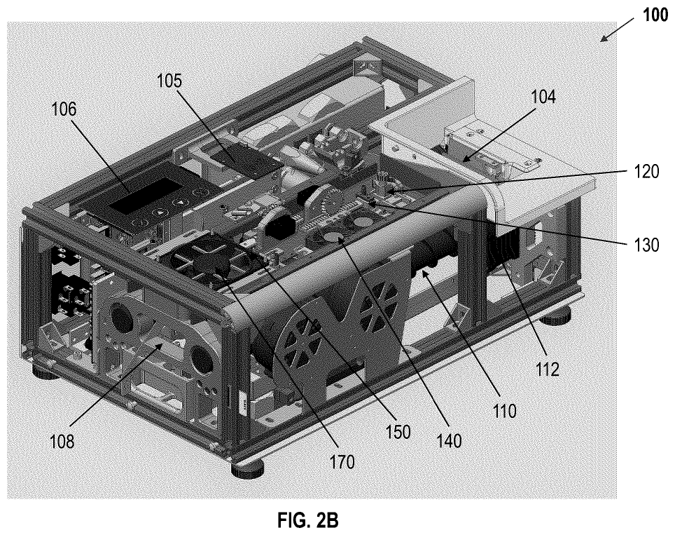

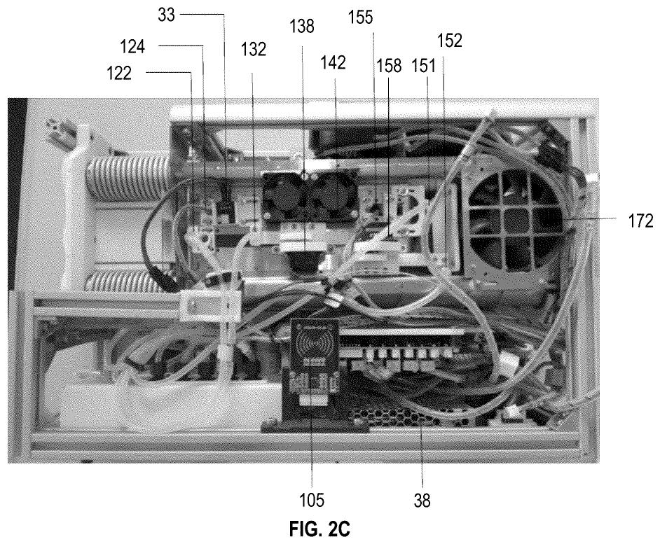

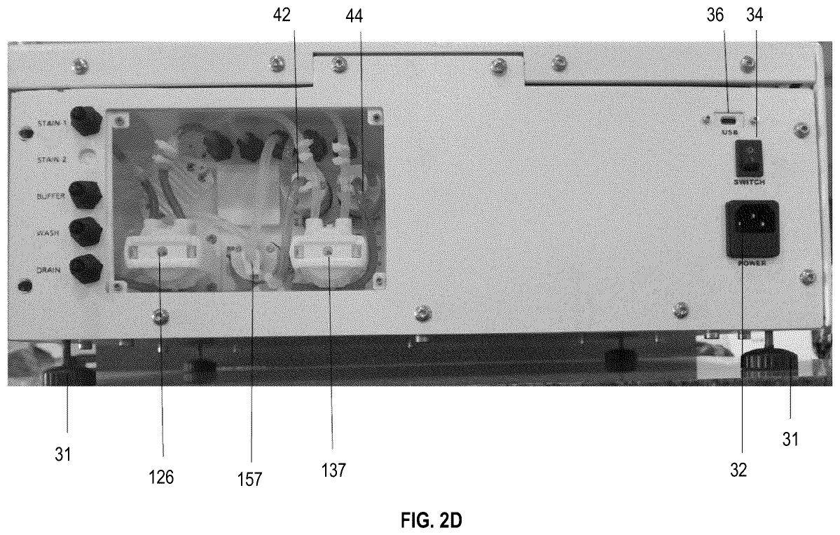

FIGS. 2A-2B show interior views of the staining device (or staining system) 100 depicting various systems of the staining device 100, according to an embodiment of the current disclosure. The staining device 100 can include various systems or stations associated with different steps of the automated staining process. In brief, overview, the staining device 100 can include a slide transport system 110, a stain dispensing system 120 (also referred to as “staining station”), a buffering system 130 (also referred to herein as “buffering station”), a mixing system 140 (also referred to herein as “mixing station”), a washing system 150 (also referred to herein as “washing station”), a wiping system 160 (also referred to herein as “wiping station”) and a drying system 170 (also referred to herein as “drying station”).

In some implementations, the staining device 100 may not include all of these systems but rather a subset of the systems 110, 120, 230, 140, 150, 160 and/or 170. For example, the staining device 100 may not include the washing system 150, the wiping system 160 and/or the drying system 170. For instance, steps associated with any of these systems or stations may be performed by another device or manually by an operator. In some implementations, any of the systems 110, 120, 230, 140, 150, 160, 170 and/or any other systems or components described herein can be implemented or integrated in other types of devices, e.g., other types of medical devices.

The slide transport system 110 is designed, constructed, configured or structured to carry or convey the slides 10 along a predefined path or trajectory along which various steps of the staining process are performed or executed. In particular, the stain dispensing system 120, the buffering system 130, the mixing system 140, the washing system 150, the wiping system 160 and/or the drying system 170 can be arranged or positioned at different positions along the predefined path or trajectory defined by the slide transport system 110. As the slide transport system 110 causes the slide 10 to move along the predefined path or trajectory, the systems 120, 230, 140, 150, 160 and/or 170 can be triggered or actuated. The slide transport system 110 can include a motor 112 and one or more members, such as members 114a and 114b. The one or more members are referred to hereinafter, either individually or collectively as member(s) 114. The one or more members 114 can be mechanically coupled to the motor 112. The one or more members 114, when actuated by the motor 112, cause the slide 10 to move along the predefined path. Additional details about the members 114 are provided below.

The stain dispensing system 120 can include a stain dispensing nozzle arranged at a first position along the predefined path and configured to release the staining solution on the slide 10. The stain dispensing system 120 or the stain dispensing nozzle can be configured to dispense one or more drops, or a predefined quantity, of the staining solution onto the slide 10 as the slide 10 passes by the stain dispensing system 120.

The buffering system 130 can include a buffer dispensing nozzle arranged at a second position along the predefined path and configured to release the buffering solution on the slide 10. The buffering system 130 or the buffer dispensing nozzle can be configured to dispense one or more drops, or a predefined quantity, of the buffer solution onto the slide 10 as the slide 10 passes by the buffering system 130.

The mixing system 140 can include one or more fans arranged at a third position along the predefined path and configured to circulate air towards the slide 10, as the slide passes by the mixing system 140, and cause mixing of the staining solution and the buffer solution on the slide 10. The third position can be subsequent to the first and second positions along the predefined path so that the mixing of the staining and buffer solutions is performed after both solutions are released on the slide 10.

The washing system 150 can include a washing nozzle arranged at a fourth position along the predefined path and configured to release a washing solution on the slide 10. The fourth position can be subsequent to the third position of the mixing system 140. The washing system 150 or washing nozzle can be configured to wash the mixture of the staining and buffer solutions with the same buffer solution or other buffer solution, such as distilled water.

The wiping system 160 can include one or more sweeping members (also referred to herein as one or more sweeping elements) arranged to wipe one or more surfaces of the slide 10. The sweeping member(s) can remove liquid remaining on the one or more surfaces, e.g., after the washing of the slide 10. The wiping of the surface(s) of the slide 10 can help speed up the drying process as most of the liquid on the surface(s) is removed by the sweeping member(s).

The slide drying system 170 can include at least one other fan (e.g., apart from the fan(s) of the mixing system 140) placed at a fifth position along the predefined path and configured to circulate air to dry any liquid left on the slide 10. The slide drying system 170 or the at least one other fan can be configured to dry the slide 10 after the washing step and before the slide is provided for study under a microscope.

The staining device 100 can include a circuit board 103 including circuitry (e.g., one or more circuits) configured to control operations and/or systems or components of the staining device 100. For instance, the one or more circuits can include one or more processors and/or one or more controllers to trigger, deactivate, or otherwise control operations of the systems and/or components of the staining device 100. The circuitry can be communicatively coupled to the interface 106. For example, instructions and/or setting parameters input by the operator via the interface 106 can be communicated to the circuit board (or the one or more circuits thereon) for use in controlling operations of the operations of the systems and/or components of the staining device 100.

The staining device 100 can include a communication interface 105, such as a wireless communication interface or a radio frequency (RF) communication interface, for communicating with remote devices such as a desktop, a laptop, mobile device and/or computer servers among others. In some implementations, setting parameters and/or instructions can be communicated to the staining device 100 from one or more remote devices via a communication network, such as a Wi-Fi network, a local area network, the Internet and/or other types of networks. In some implementations, the staining device 100 can communicate with remote devices via wired links (e.g., via a USB port 36), BLUETOOTH, near field communication and/or other types of communications.

The staining device 100 can include adjusting legs 31 for leveling the staining device 100. The staining device 100 can include a power socket 32 for connecting the staining device to a power source. The staining device 100 can include and ON/OFF switch 34 for turning the staining device 100 on and off and a switched-mode power supply (SMPS) 38. The staining device 100 can include a humidity sensor 33 for measuring humidity within the staining device 100.

In some implementations, the staining device 100 can be configured to perform only a subset of the steps associated with the staining process. For instance, the staining device 100 can be configured to automatically release or dispense the stain and buffer solution on the slide and mix both solutions on the slide 10. As such, the washing, wiping and/or drying of the slide may be performed manually or by another device or system. The staining device 100 can include motor 112 and one or more members 114 mechanically coupled to the motor 112. The one or more members 114 when actuated by the motor 112 can cause the slide 10 including a sample or specimen (e.g., a smear) placed thereon to move along a predefined path. The staining device 100 can include a first nozzle (e.g., stain dispensing nozzle) arranged at a first position along the predefined path and configured to release a staining solution on the slide, a second nozzle (e.g., buffer dispensing nozzle) arranged at a second position along the predefined path and configured to release a buffer solution on the slide, and one or more fans arranged at a third position along the predefined path and configured to circulate air towards the slide 10 and cause mixing of the staining solution and the buffer solution on the slide. The staining device 100 may further include other systems, such as any combination of systems 150, 160 and/or 170, and/or other systems or components.

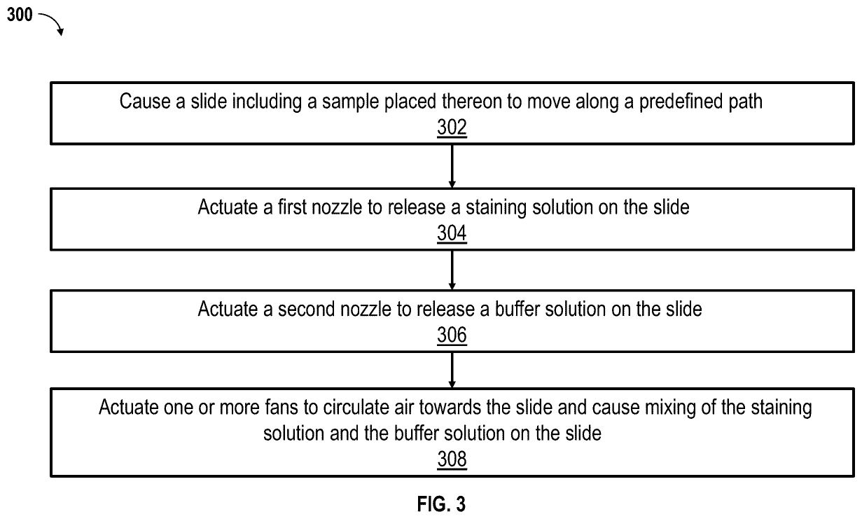

Referring now to FIG. 3, a flow chart of a method 300 for automatically staining slides 10 is shown, according to an embodiment of the current disclosure. In brief overview, the method 300 can include causing a slide 10 including a sample placed thereon to move along a predefined path (STEP 302), actuating a first nozzle (e.g., stain dispensing nozzle) to release a staining solution on the slide 10 (STEP 304), actuating a second nozzle (e.g., buffer dispensing nozzle) to release a buffer solution on the slide 10 (STEP 306) and actuating one or more fans to circulate air towards the slide 10 and cause mixing of the staining solution and the buffer solution on the slide 10 (STEP 308). The method 300 can be performed by staining device 100 or one or more systems, circuits and/or components thereof. For instance, the method 300 can be performed by one or more controllers and/or one or more processors of the staining device 100.

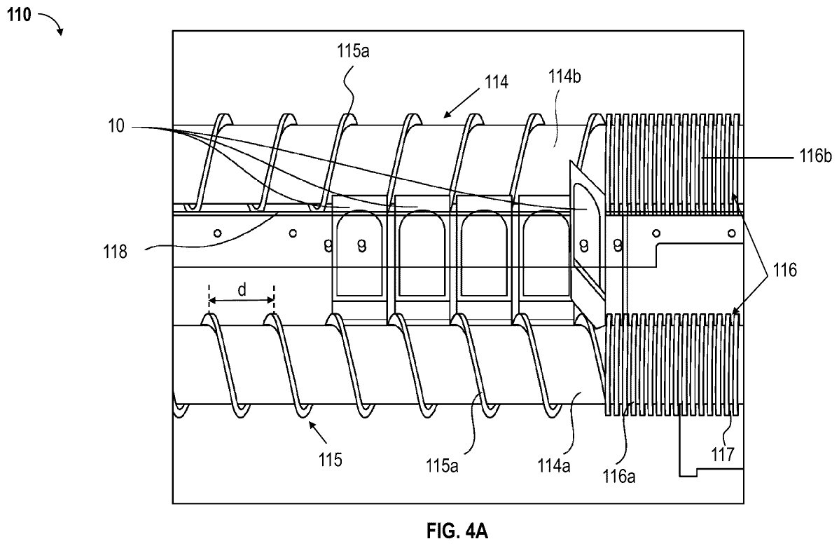

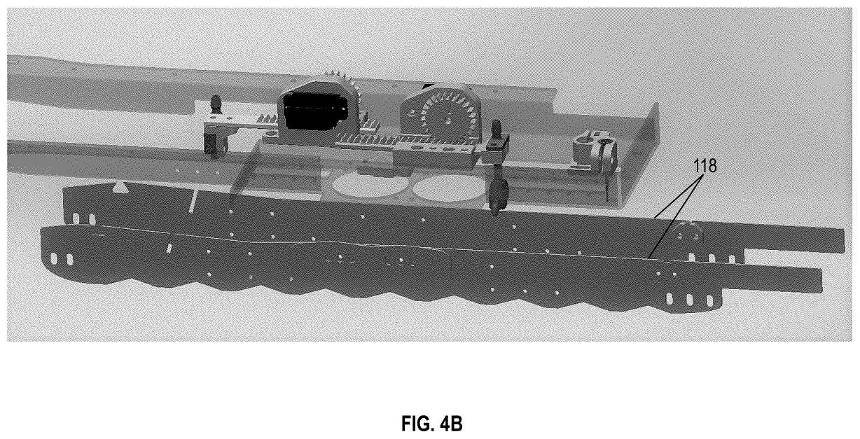

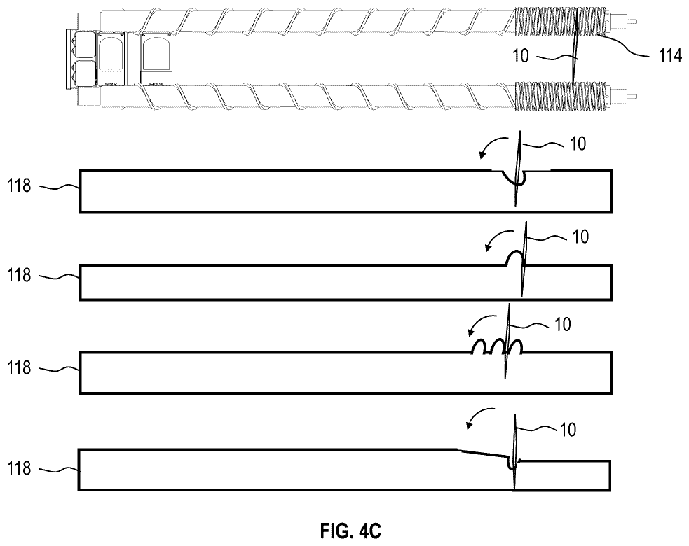

The method 300 can include causing, by a motion actuator, movement of slide 10 including a sample placed thereon along a predefined path (STEP 302). The motion actuator can include motor 112. The motion actuator can also include one or more members 114 mechanically coupled to the motor 112. In some implementations, an operator of the staining device 100 can trigger or actuate the motion actuator or the motor 112 by powering on or initiating the staining device 100 or interacting with a button or icon of the interface 106. In some implementations, a surface of the slide 10 on which the sample or specimen (e.g., a smear) is placed is facing upward while the slide 10 moves along the predefined path. The surface of the slide opposite to the surface of the slide on which the smear is placed is facing downwards and is resting on the slide transport system 110, for example, the support members or rails 118, as the slide 10 is conveyed along the predefined path. The thin surfaces of the slides connecting the two surfaces facing upward and downwards form the edges of the slide and the longer two edges extend between the first rail and the second rail of the slide transport system. The two shorter edges include a head edge and a tail edge. The head edge is proximate to the label of the slide relative to the tail of the smear while the tail edge is proximate to the tail of the smear relative to the label of the slide. The head edge is proximate to the member 114a as shown in FIG. 4A, while the tail edge is proximate to the member 114b as shown in FIG. 4A.

The method 300 can include automatically actuating a first nozzle arranged at a first position along the predefined path to release the staining solution on the slide 10 responsive to determining that a first actuation condition is satisfied (STEP 304). In some implementations, the first actuation condition can include detecting or determining that the slide 10 reached the first position along the predefined path or trajectory. For instance, a controller or processor of the staining device 100 can actuate the first nozzle upon detecting or determining that the slide 10 is aligned with first nozzle, e.g., along a dimension transverse to the predefined path or trajectory. The first nozzle can be a stain dispensing nozzle.

The method 300 can include actuating a second nozzle arranged at a second position along the predefined path to release a buffer solution on the slide responsive to determining that a second actuation condition is satisfied (STEP 306). In some implementations, the second actuation condition can include detecting or determining that the slide 10 reached the second position along the predefined path or trajectory. For instance, a controller or processor of the staining device 100 can actuate the second nozzle upon detecting or determining that the slide 10 is aligned with second nozzle, e.g., along a dimension transverse to the predefined path or trajectory. The second nozzle can be a buffer dispensing nozzle.

The method 300 can include actuating, responsive to determining that a third actuation condition is satisfied, one or more fans arranged at a third position along the predefined path to circulate air towards the slide and cause mixing of the staining solution and the buffer solution on the slide (STEP 308). In some implementations, the third actuation condition can include detecting or determining that a relative proximity between the slide 10 and the one or more fans is within a predefined range, equals a predefined value or satisfies some other condition. For instance, a controller or processor of the staining device 100 can actuate the one or more fands upon detecting or determining that the relative proximity between the slide 10 and the one or more fans is within the predefined range, equals the predefined value or satisfies some other condition.

The slide 10 can be arranged or positioned horizontally with the surface of the slide including the sample or specimen facing upward as the slide 10 moves along at least a portion of the predefined path. The portion of the predefined path can be associated with or can include the first position of the first nozzle along the predefined path, the second position of the second nozzle along the predefined path and the third position of the one or more fans along the predefined path.

The staining device 100 and the method 300 are described in further detail below. In particular, various systems and/or components, such as systems 110, 120, 130, 140, 15, 160 and 170, as well as the corresponding functions and/or operations are described in further detail below. Any of these systems and/or components as well as any of the corresponding functions and/or operations can be integrated in the staining device 100 or the method 300. It is to be noted however, even though these systems and/or components as well as the corresponding functions and/or operations are described in relation with the automatic staining of slides 10, any of these systems and/or components as well as any of the corresponding functions and/or operations can be integrated in other devices, systems or methods.

### A. Slide Transport System

The slide transport system 110 can be configured to transport or carry slides 10. For example, the slide transport system 110 can convey the slides 10 or cause movement of the slides 10 along a predefined path to be processed, treated or prepared for analysis via a microscope. In some implementations, the slide transport system 110 can carry slides 10 across various stations or systems associated with various steps of a staining process. In general, the slide transport system 110 (also referred to herein as a “motion actuator” or “slide movement actuator”) can include one or more members mechanically coupled to a motor 112. The one or more members when actuated by the motor 112 can cause the slides 10 to move along a predefined path.

The slide transport system 110 can be designed, constructed, configured or structured to convey a plurality of slides along the path. In some embodiments, the opening 104 defined by the housing 102 of the staining device 100 can include a plurality of slots. Each slot of the plurality of slots is configured to receive a slide. In some embodiments, the number of slots exposed by the opening can be anywhere from 1-50 such that up to 50 slides can be loaded on the plurality of slots. In some embodiments, a user can continually load slides 10 to the slots.

FIG. 4A depicts a top view of the slide transport system 110 shown in FIGS. 2A and 2B, according to an example embodiment of the current disclosure. In brief overview, the slide transport system 110 can include a pair of members 114a and 114b mechanically coupled to the motor 112 and a pair of support members or rails 118. The members 114a and 114 are referred to herein individually or in combination as member(s) 114. The members 114a and 114b can be arranged parallel to each other. The motor 112, while not shown in FIG. 4A, can be viewed as a component of the slide transport system 110 or as an actuator that is mechanically coupled to the slide transport system 110 or the corresponding member(s) 114.

Referring to FIGS. 2A, 2B and 4, each of the members 114 can be a rod (also referred to herein as a screw rod) configured or structured to rotate when actuated by the motor 112. Each of the members 114 can include a first portion having a male thread 116 (e.g., at one end of the members) and a second portion including a protruding helical structure 115. For instance, the member 114a includes male thread 116a and protruding helical structure 115a, and the member 114b includes male thread 116b and protruding helical structure 115b. The members 114 can be arranged such that the corresponding male thread(s) 116 are exposed by the opening 104 of the housing 102. The protruding helical structures 115 may be arranged within the housing 102.

The grooves 117 of the male threads 116 can be configured or structured to receive the slides 10. The grooves 117 can serve as slots to receive the slides. As depicted in FIGS. 1B and 1C, an operator. As depicted in FIGS. 1B and 1C, an operator can place a slide 10 within aligned groove portions of the male threads 116a and 116b. Each aligned pair of groove portions (e.g., a first groove portion of male thread 116a and a second groove portion of male thread 116b that are substantially aligned with each other) can form a slot structured to receive a slide 10, e.g., when the slide is placed vertically. The groove portions may define recesses that are sized to receive the slide. In particular, each substantially aligned pair of groove portions can receive opposite ends of the slide 10, respectively. The portions of the members 114 corresponding to the male threads 116 can receive a plurality of slides to be processed (e.g., to be stained).

In some implementations, the pitch of the male thread can be about 5 mm (e.g., 4.75 mm), the depth of the groove 117 can be between 4 to 6 mm (e.g., 5.2 mm). The male thread can be a tapered male thread. In some implementations, the pitch, and depth of the groove 117 can be designed such that a slide 10 cannot be placed within non-aligned grove portions as such placement could damage the slide or the sample thereon when the slide switch from a vertical position to a horizontal position at the end of the male thread 166 and the start of the helical structure 115.

The total number of slides that can be accommodated simultaneously by the male threads 116 can be equal to the length of the male thread divided by the pitch of the thread. The use of the male thread portions allows the operator to place a relatively large number (or a patch) of slides 10 for processing at once and come back at a later time to pick the slides when processing is complete. In some implementations, the slide transport system 110 can include a support structure 111 to provide support for the slides 10 placed in groove portions (or slots) of the male threads 116a and 116b.

The members 114 can be mechanically coupled to the motor 112. The members 114 may also be mechanically coupled to each other. As depicted in FIG. 1A, the members 114 can be mechanically couped to the motor 112 and/or to each other via one or more gears, such as gears 113a-113d which are referred to herein individually or in combination as gear(s) 113. For example, gears 113a and 113d can be mounted, fastened or attached to the members 114, gear 113b can be mounted, fastened or attached to the motor 112 or a shaft thereof, and gear 113c can mechanically couple gears 113b and 113d. When the motor 112 is actuated, the motor causes gear 113b to rotate, which in turn causes rotation of gears 113a and 113c. Gear 113c cause rotation of gear 113d. The rotation of gears 113a and 113d and causes rotation of members 114a and 114b, respectively.

The mechanical coupling between the motor 112 and the members 114 allows for transfer of rotational motion from the motor 112 to the members 114. The mechanical coupling between the members 114 allows for motion synchronization of the members 114 and maintaining alignment between portions of thread grooves of the members 114 to receive slides 10. Maintaining alignment between portions of thread grooves of the members 114 allows for the slide 10 to be placed substantially perpendicular to a longitudinal dimension of the members, which in turn leads to securing the slide 10 within an opposite and aligned pair of groove portions of the members.

As the members 114 rotate, the slide 10 moves along the longitudinal dimension of the members 114 towards the second portions of the members 114 including the protruding helical structures 115. The first portions or the corresponding male threads 116a and 116b can have substantially the same length. At the boundary between the male threads 116a and 116b and the helical structures 115a and 115b, respectively, the slide 10 transitions (e.g., slowly or gradually) from a vertical position to a horizontal position. Compared to the male threads 116, the helical structures 115 are configured or structured to have a greater pitch or spacing d between consecutive protruding portions along the longitudinal dimensions of the members 114.

Referring back to FIG. 4A, the slides 10 are arranged horizontally along the portions of the members 114 associated with the protruding helical structures 115. The pitch or spacing d of the helical structures 115 can be configured such that each slide 10 or corresponding dimension thereof (e.g., a width dimension) fits in between two consecutive crests protrusions of the helical structure along the longitudinal dimension of the members 114. For instance, the pitch or spacing d of the helical structures 115 can be slightly (e.g., 3 to 5 millimeters) greater than the dimension (e.g., width dimension) of the slide 10. The width of slide is about 25 mm. In some embodiments, d is about 29 millimeters and the inner spacing between consecutive helical structures can be about 26 to 27 mm. The protruding helical structures 115 engage the slide 10 and cause the slide 10 to move along the predefined path (e.g., along the longitudinal dimension of the members 114). The operator can place the slides 10 in groove portions of the male threads 116 with surface including the sample or specimen facing in a given direction (e.g., facing in direction opposite to the direction of motion of the slides 10) so that when the slides 10 transition to the horizontal position at portions corresponding to the helical structure 115, the surface of the slide 10 carrying the sample or specimen (e.g., smear) is facing upward.

The slide transport system 110 can include one or more support members or rails 118 extending along the predefined path. The one or more support members or rails 118 are configured or structured to support the slides 10 as they move along the predefined path, or at least along the portions of the members 114 associated with the protruding helical structures 115. In some implementations, the support member(s) or rail(s) 118 can include a pair (or set) of rails or rail beds, a pair of blades or a pair of cables to support the slides 10.

In some implementations, the one or more members 114 of the slide transport system 110 can include one or more belts (e.g., one or more cleated belts) actuated by a motor, e.g., motor 112. For example, a first portion of the belt(s) can be exposed at the opening 104 for the operator to place the slides for processing. The slides 10 can be placed horizontally, e.g., with the slide surface carrying the sample or specimen facing upward. The belt(s) may have cleats configured or structured to mechanically engage the slides and secure each slide 10 at a corresponding position on the belt(s). when actuated by the motor 112, the belt(s) can move and cause movement of the slides 10 along a predefined path.

Referring now to FIGS. 4B and 4C, various aspects of support members or rails 118, according to example embodiments of the current disclosure. The support members or rails 118 include a pair of rails or rail beds for supporting the slide 10 along the predefined path. The use of a pair or set of rails leaves the upper and bottom surfaces of the slides 10 exposed while providing reliable support.

FIG. 4C depicts various novel features of the support members or rails 118, according to an example embodiment. At the end of the male thread 116 and start of the helical structure 115, the slide 10 is expected or desired to rotate forward (as shown by the arrows) to switch from a vertical position to a horizontal position. However, at this phase, the slide may slip on the support members or rails 118 and rotate backward. In such case the surface of the slide including the sample, specimen or smear will end up facing downward and the staining or processing of the slide 10 will fail. To prevent such a scenario, the support members or rails 118 can include at least one of groove, one or more bumps (or protrusions) or an upward inclination at level corresponding to the end of the male thread and start of the helical structure. For instance, the support members or rails 118 can include a single groove, a single bump (or protrusion), multiple bumps (or protrusions), an upward inclination/slope or a combination thereof to prevent the slide from slipping.

### B. Stain Dispensing Station or System

The stain dispensing system 120 is configured to automatically release or dispense a stain or staining solution on a slide 10 responsive to a trigger event. The staining solution can include natural and/or synthetic stain(s) and is used to add color to the colorless sample or specimen. The trigger event can be related to the position of the slide 10 relative to the stain dispensing system 120 to ensure that the released stain or staining solution lands on the slide 10.

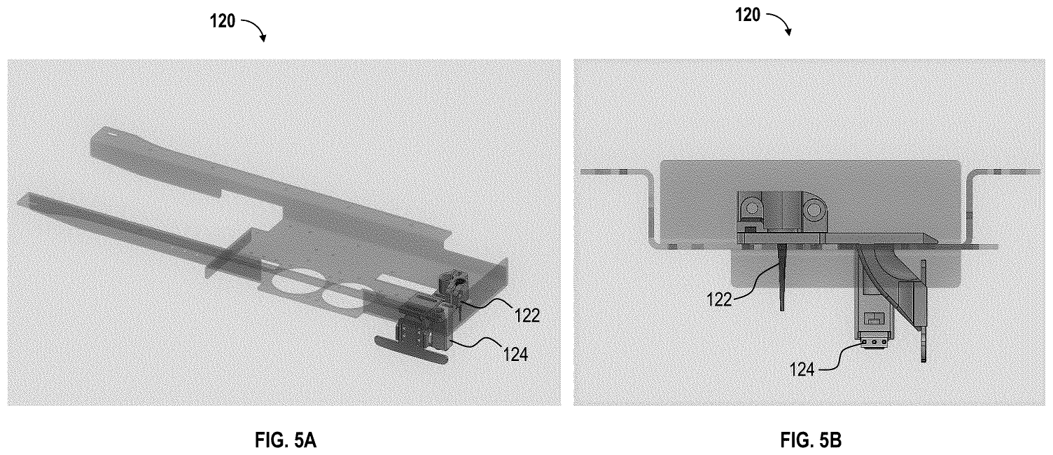

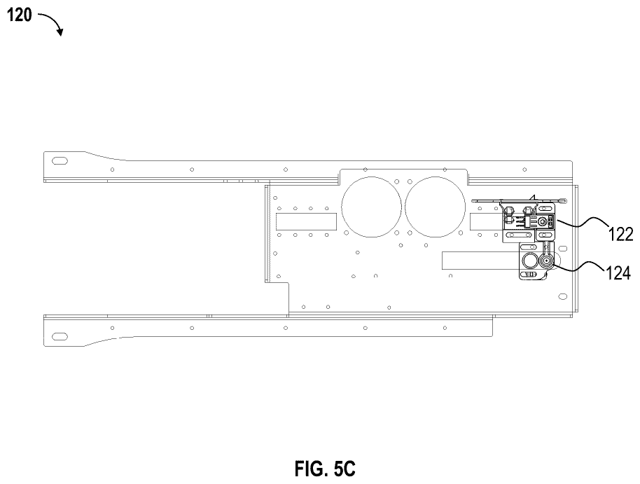

FIGS. 5A-5C depict different views of a stain dispensing system 120 for automatically releasing, dispensing or delivering a staining solution on slides 10, according to an embodiment of the current disclosure. In brief overview, the stain dispensing system 120 can include a stain dispensing nozzle 122 for dispensing or releasing the staining solution and a sensor 124 for detecting presence of a slide 10 at a predefined position.

The sensor 124 can include a light sensor, such as an infrared (IR) sensor, a light detection and ranging (LIDAR) sensor, an X-ray sensor, a sonar sensor or an electromagnetic sensor among others. The sensor 124 can be placed at same level or position (or at substantially the same level or position) along the predefined path as the stain dispensing nozzle 122. Given that most slides are usually made of glass, the change in the signal produced by the sensor 124 caused by a slide 10 may be relatively small. For instance, with regard to IR sensors, only a small portion of the light may be reflected or refracted by the slide 10. To enhance reliability and accuracy of slide detection, the sensor 124 can be arranged or positioned at distance less than or equal to 10 millimeters (mm) above the slide 10 (e.g., when the slide passes beneath the stain dispensing nozzle 122). In other words, the distance between the slide path and the sensor 124 along a z-axis (e.g., an axis pointing vertically or upward) can be less than or equal to 10 mm. In some implementations, the sensor 124 can have a cover or protection to prevent, avoid or mitigate the staining solution splashing the sensor 124 when released on the slide 10.

As the slide passes beneath the stain dispensing nozzle 122, the sensor 124 can detect the presence of the slide 10 and send an indication of the slide detection event to the circuit board 103 and/or to a controller or processor thereof. In response, the controller, processor or circuitry on the circuit board 103 can trigger release or dispensing of the stain solution on the slide 10.

It should be appreciated that the sensor 124 may be positioned in other positions along the path but is used to determine a time at which a slide is going to pass beneath the stain dispensing nozzle 122. This can be determined because the speed at which the slides are moving is known and can be determined by the motor used to actuate the support members or rails 118 that convey the slides. Similarly, other position sensors can be positioned anywhere but used to determine the position of slides as they are carried along the path.

The stain dispensing nozzle 122 can be connected or coupled to the stain container 22, e.g., through at least a tube or other fluid carrying component. In some implementations, the stain dispensing system 120 can include a peristaltic pump 126 (as shown in FIG. 2D) configured to pump the stain (or staining solution) from the stain container 22 into a corresponding tube to be released through the stain dispensing nozzle 122. When a slide 10 is detected (e.g., beneath the stain dispensing nozzle 122) by the sensor 124, the controller, processor or circuitry on the circuit board 103 can trigger or actuate the peristaltic pump 126 to pump an amount of the stain solution to be released on the slide 10, e.g., via the stain dispensing nozzle 122. In some implementations, the stain dispensing system 120 can include an automatic dispensing device. When a slide 10 is detected (e.g., beneath the stain dispensing nozzle 122) by the sensor 124, the controller, processor or circuitry on the circuit board 103 can trigger or actuate the automatic dispensing device to release or dispense an amount of the stain solution to be released on the slide 10, e.g., via the stain dispensing nozzle 122. In some embodiments, the controller, processor or circuitry on the circuit board 103 can trigger or actuate the automatic dispensing device to release or dispense an amount of the stain solution to be released on the slide 10, e.g., via the stain dispensing nozzle 122 responsive to determining that the slide is passing beneath the stain dispensing nozzle 122 based on one or more sensors of the staining device 100 detecting the position of the slide as the slide passes one or more predetermined portions of the path.

Referring back to FIGS. 1A-3, the staining device 100 and/or the method 300 can include any of the steps or features described in this section.

### C. Buffering Station or System

The buffering system 130 is configured to automatically release or dispense a buffer solution on a slide 10 responsive to a trigger event. The buffer solution is used to neutralize small amounts of acids or bases and maintain the pH level at the sample or specimen (e.g., smear) to a certain value or within a fairly narrow range. The trigger event can be related to the position of the slide 10 relative to the buffering system 130 to ensure that the released buffer solution lands on the slide 10.

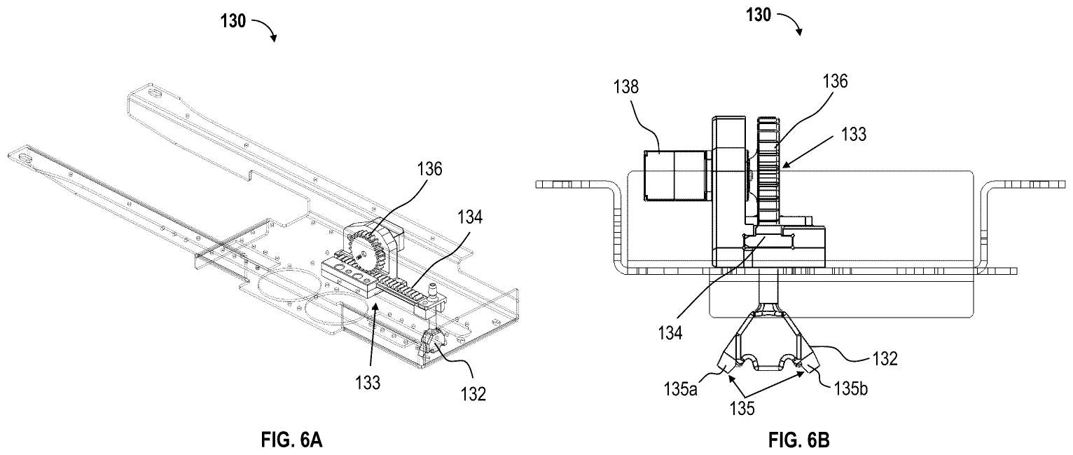

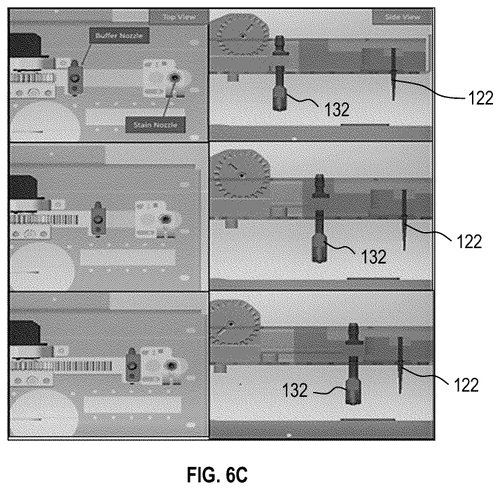

FIGS. 6A-6C depict a buffering system 130 for automatically releasing or dispensing a buffer solution on slides 10, according to an embodiment of the current disclosure. The buffering system 130 can include buffer dispensing nozzle 132 configured to release or dispense the buffer solution, e.g., from buffer container 24, on the slide 10 responsive to determining the slide 10 to be positioned or arranged beneath buffer dispensing nozzle 132. In some implementations, the controller, processor or circuitry on the circuit board 103 can trigger or actuate dispensing or release of an amount of the buffer solution through the buffer dispensing nozzle 132 responsive to determining that slide 10 is beneath the buffer dispensing nozzle 132. For instance, the controller, processor or circuitry can determine the slide 10 to be beneath the nozzle using the time instance at which the slide 10 was detected by sensor 124, the distance between the stain dispensing nozzle 122 and buffer dispensing nozzle 132 (or between the stain dispensing system 120 and the buffering system 130) and a speed of the slide 10. In some embodiments, the controller, processor or circuitry on the circuit board 103 can trigger or actuate the buffering system to release or dispense an amount of the buffer solution to be released on the slide 10, e.g., via the buffer dispensing nozzle 132 responsive to determining that the slide is passing beneath the buffer dispensing nozzle 132 based on one or more sensors of the staining device 100 detecting the position of the slide as the slide passes one or more predetermined portions of the path.

In some implementations, the motor 112 can include or can be a stepper motor. Given a distance between the stain dispensing nozzle 122 and the buffer dispensing nozzle 132, the controller, processor or circuitry can determine the number of angular steps that need to be made by the motor 112 after the slide 10 is detected by sensor 124 for the slide to reach (or be beneath) the buffer dispensing nozzle 132. Responsive to determining that such number of angular steps are made by the motor 112, the controller, processor or circuitry can trigger actuate the release of the buffer solution (or an amount thereof) on the slide.

The buffer dispensing nozzle 132 can be connected or coupled to the buffer container 24, e.g., through at least a tube or other fluid carrying component. In some implementations and as depicted in FIG. 2D, the buffering system 130 can include a peristaltic pump 137 (as shown in FIG. 2D) configured to pump the buffer solution from the buffer container 24 into a corresponding tube to be released through the buffer dispensing nozzle 132. When the slide 10 is determined to be beneath the buffer dispensing nozzle 132, the controller, processor or circuitry on the circuit board 103 can trigger or actuate the peristaltic pump 137 to pump an amount of the buffer solution to be released on the slide 10, e.g., via the buffer dispensing nozzle 132.

In some implementations, the buffering system 130 can include an automatic dispensing device. When the slide 10 is determined to be beneath the buffer dispensing nozzle 132, the controller, processor or circuitry on the circuit board 103 can trigger or actuate the automatic dispensing device to release or dispense an amount of the buffer solution to be released on the slide 10, e.g., via the buffer dispensing nozzle 132.

Referring back to FIGS. 6A-6C, the buffering system can include an actuator 133 configured to adjust a distance between the stain dispensing nozzle 122 and the buffer dispensing nozzle 132 along the predefined path. For instance, the actuator 133 can be configured to cause displacement of the buffer dispensing nozzle 132 along the predefined path to adjust the distance between the stain dispensing nozzle 122 and the buffer dispensing nozzle 132 along the predefined path.

In some implementations, the actuator 133 can include a rack and pinion system. The rack and pinion system can include a rack member 134 and a gear 136 (e.g., a pinion gear). The buffer dispensing nozzle 132 can be fixed, fastened or secured to the rack member 134. The rack member 134 and the gear 136 can be structured or configured such that the gear 136 engages the rack member 134. When the gear 136 rotates, it causes the rack member 134 and the buffer dispensing nozzle 132 to exhibit a linear motion resulting in a displacement of the buffer dispensing nozzle 132 along the predefined path.

The possibility to adjust the position of the buffer dispensing nozzle 132 along the predefined path allows for controlling a time difference or a waiting time between the release of the stain and the release of the buffer solution on the slide 10. Such waiting time can differ based on the type of stain used and/or a staining protocol employed by the operator or a lab associated with the staining device 100. For example, some operators or staining protocols may seek a relatively darker staining than other operators or protocols, which calls for a relatively longer waiting time. In other words, the actuator 133 allows controlling the positioning of buffer dispensing nozzle 132 to increase or decrease the stain/buffer timing ratio of the staining process, which allows the staining device 100 to accommodate various stains and/or various staining protocols. FIG. 6C shows various scenarios with different distances between the stain dispensing nozzle 122 and buffer dispensing nozzle 132.

In some implementations, the adjustment of the position of the buffer dispensing nozzle 132 or the distance between the stain dispensing nozzle 122 and the buffer dispensing nozzle 132 can be achieved manually. For example, a sliding bar (or some other mechanism) engaging the gear 136 can be exposed on the housing 102 (or via aperture in the housing 102). The operator of the staining device 100 can adjust the position of the buffer dispensing nozzle 132 (or the distance between the stain dispensing nozzle 122 and buffer dispensing nozzle 132) by actuating or moving the sliding bar (or some other mechanism) engaging the gear 136. In some implementations, the adjustment of the position of the buffer dispensing nozzle 132 or the distance between the stain dispensing nozzle 122 and buffer dispensing nozzle 132 can be automatic. For instance, the buffering system 130 or actuator 133 can include a servomotor 138 configured to cause rotation of the gear 136.

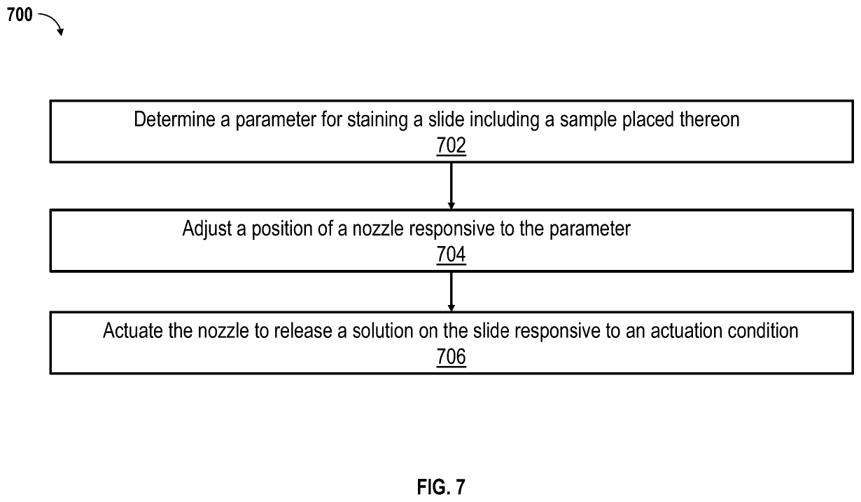

Referring now to FIG. 7, a flow chart depicting a method 700 for automatically dispensing a solution (e.g., a buffer solution) on a slide 10 is shown, according to an example embodiment of the current disclosure. The method 700 can include determining a parameter for staining a slide 10 including a sample or specimen placed thereon (STEP 702), adjusting a position of a buffer dispensing nozzle 132 responsive to the parameter (STEP 704) and actuating the buffer dispensing nozzle 132 to release an amount of a solution on the slide 10 responsive to determining that an actuation condition of the buffer dispensing nozzle 132 is satisfied (STEP 704).

The method 700 can include determining a parameter for staining a slide 10 including a sample or specimen placed thereon (STEP 702). The controller, processor or circuitry on the circuit board 103 can receive one or more setting parameters of the staining process (STEP 702). The one or more parameters can be received as input via the interface 106. The setting parameters can include a stain type, a stain brand, a staining protocol, or a desired waiting time between release of the stain and the buffer solution, among others. The parameter can also include a stain intensity or any other information or value that would correspond to a stain intensity. In some embodiments, the parameter could be a parameter, which when selected, causes the staining of the sample or specimen to have a desired stain intensity.

The method 700 can include adjusting a position of a buffer dispensing nozzle 132 responsive to the parameter (STEP 704). The controller, processor or circuitry on the circuit board 103 can determine a distance by which the buffer dispensing nozzle 132 is to be displaced (or a length by which the distance between the stain dispensing nozzle 122 and buffer dispensing nozzle 132 is to be adjusted) based on the one or more setting parameters of the staining process. In response, the controller, processor or circuitry on the circuit board 103 can trigger or actuate the servomotor 138 to cause the desired displacement of the buffer dispensing nozzle 132 (or adjustment of the distance between the stain dispensing nozzle 122 and buffer dispensing nozzle 132) according to the determined distance or length.

The method 700 can include actuating the buffer dispensing nozzle 132 to release an amount of a solution on the slide 10 responsive to determining that an actuation condition of the buffer dispensing nozzle 132 is satisfied (STEP 706). The actuation condition can be determined as discussed above. In particular, the actuation condition can include determining that slide is beneath (or substantially beneath) the buffer dispensing nozzle 132. The actuation condition can include determining the slide to be a predefined position along the predefined path.

In some embodiments, the method 700 describes adjusting a position of a buffer dispensing nozzle 132 relative to a position of the stain dispensing nozzle 122 such that an amount of time between dispensing the stain solution on the slide and the buffer solution on the slide is altered, thereby affecting the stain intensity of the slide. It should be appreciated that the systems and methods described herein are not limited to adjusting a position of the buffer dispensing nozzle 132 relative to the stain dispensing nozzle but also are intended to cover adjusting a speed at which the slide moves along the path (by adjusting the speed of the motor) or adjusting the position of the stain dispensing nozzle relative to the buffer dispensing nozzle. In some embodiments, the staining device 100 can include a heat source positioned between the staining dispensing system and the buffering system, which can be actuated at various intensities or distances from the slide to alter the stain intensity of the slide. This is because heat can impact the stain intensity of the slide. Similarly, the staining device 100 can include one or more fans positioned between the staining dispensing system and the buffering system and actuate the fans to alter the stain intensity of the slide as determined in STEP 702 or a similar step.

Referring back to FIGS. 1A-3, the staining device 100 and/or the method 300 can include any of the steps or features described in this section.

### D. Mixing Station or System

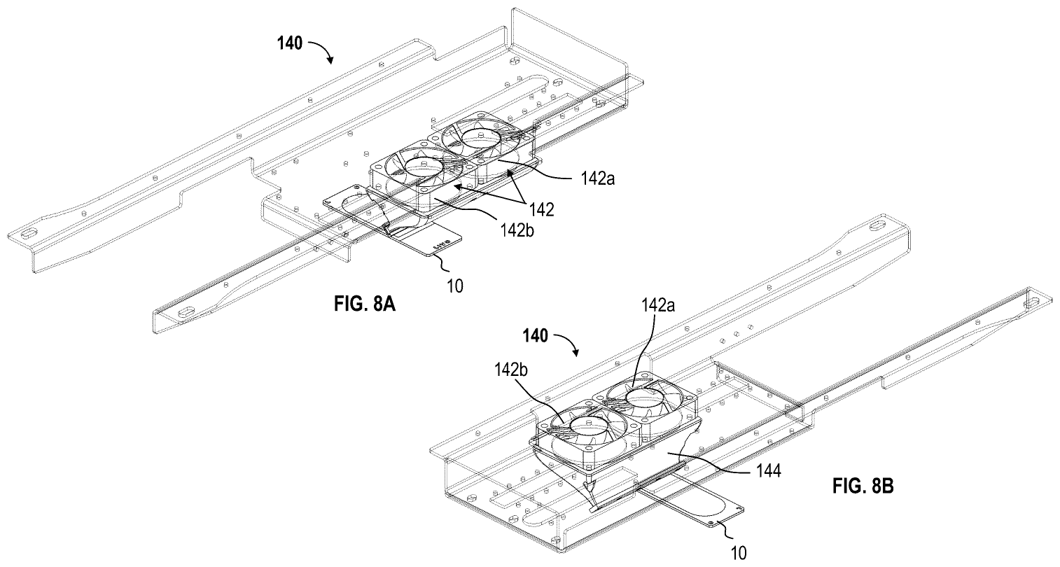

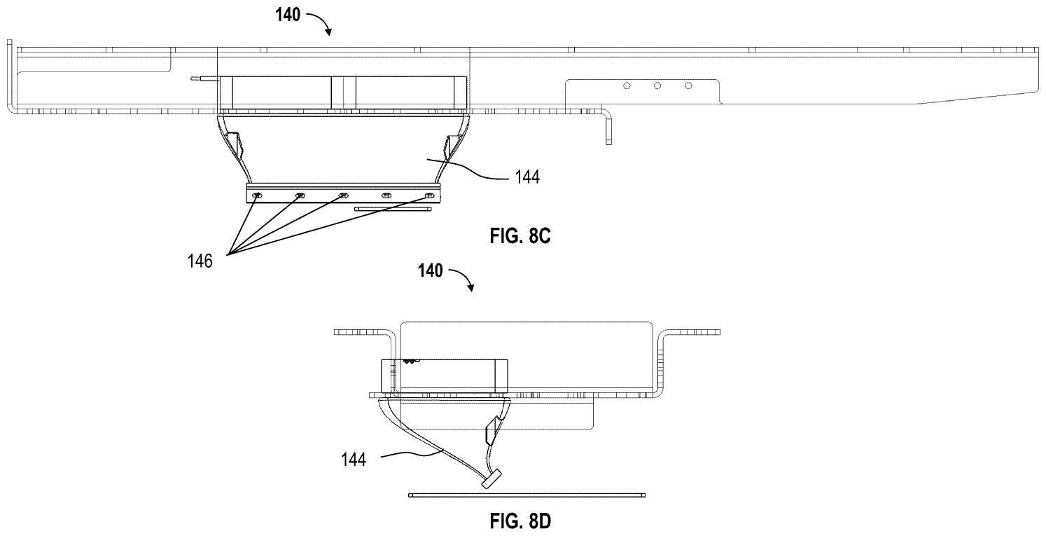

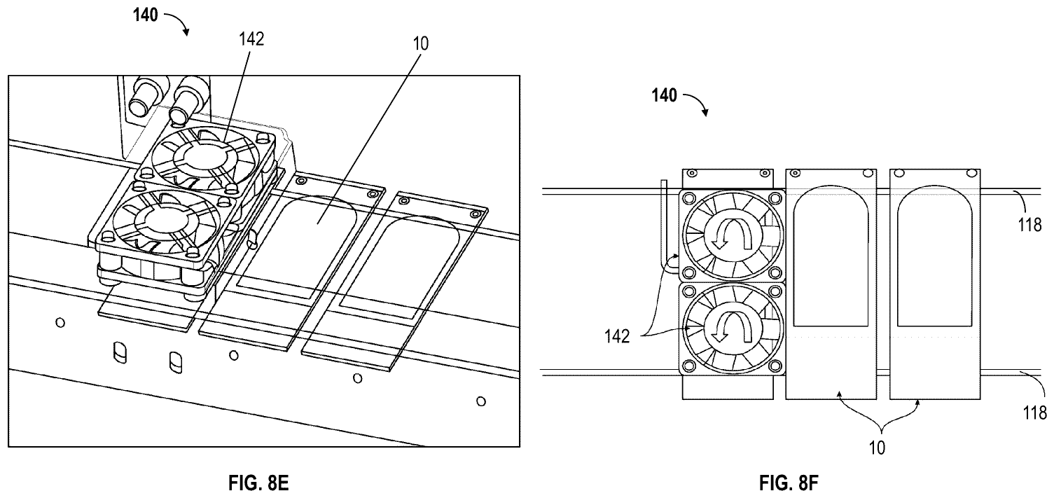

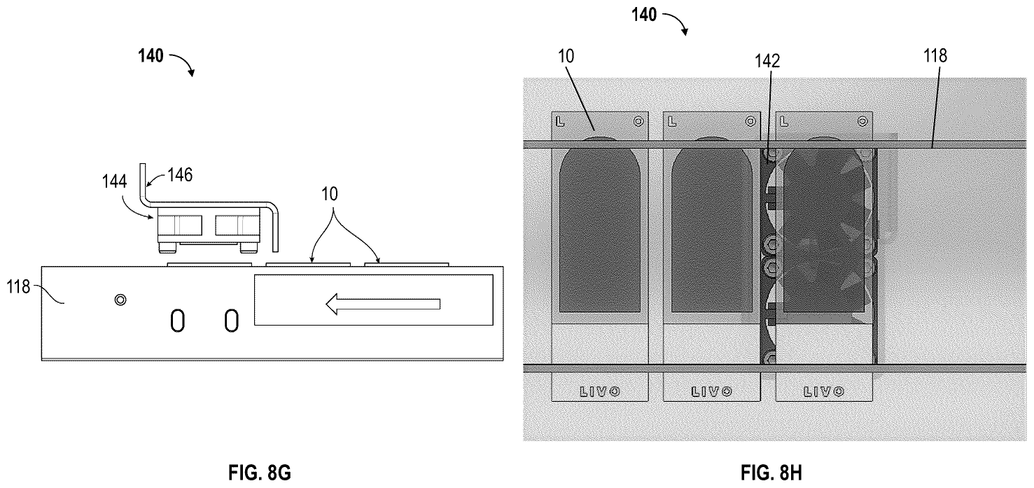

FIGS. 8A-8H depict different views and implementations of a mixing system 140 for automatically mixing solutions on slides 10, according to an embodiment of the current disclosure. FIGS. 8A-8D depict a first implementations and FIGS. 8E-8H depict another implementation of the mixing system 140. The mixing system 140 can include one or more fans 142. The mixing system 140 or the corresponding fan(s) 142 can be arranged at a third position along the predefined path. As the slides 10 move and pass by the mixing system 140 (e.g., on the support members or rails 118), the slides 10 pass beneath the one or more fans 142. The third position can be subsequent to the first position of the stain dispensing system 120 and the second position of the buffering system 130.

The one or more fans 142, when actuated, circulate air towards the slide 10 and cause mixing of the solutions on the slide 10. For example, the air circulated by the one or more fans 142 can cause mixing of the staining solution and the buffer solution released or dispensed on the slide 10. The fan(s) 142 can include a pair of fans that rotate in the same direction to achieve homogeneous mixing of the staining and buffer solutions. When the fans 142 are activated, the fans 142 can be rotated, e.g., in the same direction, at a controlled speed. The force of the air from the fans 142 mixes the staining solution and buffer solutions on the slides 10, resulting in modified pH and more efficient and effective staining. In some implementations, the processor, controller and/or circuitry may cause the fans 142 to rotate in opposite directions at controlled speed(s). While FIGS. 8A-8H show the mixing system 140 having or including two fans 142a and 142b, in general, the mixing system 140 can include any number of fans 142.

The processor, controller and/or circuitry on the circuit board 103 can control the speed and/or activation time of the fan(s) 142. Mixing the solutions with circulated air can cause fast drying of the solution(s) on the slide 10. However, fast drying at the mixing stage can lead to defective staining of the sample or specimen. The processor, controller and/or circuitry on the circuit board 103 can control the speed and/or activation time of the fan(s) 142 to avoid drying of the solution(s) on the slide 10. The processor, controller and/or circuitry on the circuit board 103 can limit the speed of the fan(s) 142 and/or activation time to corresponding predefined thresholds. The limits or ranges of acceptable fan speed and/or fan activation time can be determined based on experimental results and stored in a memory of the circuit board 103. In some embodiments, the fan speed and/or fan activation time can be determined based on the desired stain intensity and may correspond to one or more parameters selected by the operator.

In the implementation depicted in FIGS. 8A-8D, the mixing system 140 can include a channel structure 144 having one or more outlets 146. The channel structure 144 can be fluidly and/or mechanically coupled to the fan(s) 142 to channel air circulated by the one or more fans 142, via the one or more outlets 146, towards the staining solution and the buffer solution on the slide 10. In some implementations, the channel structure 144 include multiple (e.g., 4) outlets 146. The channel structure 144 limits the surface area of the slide 10 with which the air circulated by the fan(s) 142 interacts with. Instead of the having the circulated air interacting with the whole upper surface of the slide 10, the channel structure 144 limits the interaction area to the region(s) of the slide 10 associated with (e.g., facing) the outlet(s) 146, which reduces the likelihood of drying the solution(s) on the slide at the mixing stage. Stated in another way, the channel structure 144 can be configured to channel air through the outlets 146 such that the air exiting the outlets is directed to certain portions or regions of the upper surface (e.g., the surface on which the solutions are dispensed) of the slide 10.

In the implementation depicted in FIGS. 8E-8H, the fan(s) 142 are facing the path of the slide 10 (with no channel structure). In this case, the circulated air can interact with the whole of (or a majority of) the upper slide surface. To reduce the likelihood or chances of drying the solution(s) on the slide, the processor, controller and/or circuitry on the circuit board 103 can control the speed and/or activation time of the fan(s) 142 to avoid drying the solution(s) on the slide 10.

The one or more fans 142 can be mounted over or above the predefined path, at the third position, through a fan mount. For instance, the one or more fans 142 can be mounted over or above the support members or rails 118 (or rail beds) and/or at least one of the members 114. In some other implementations, mixing system 140 can include an actuator configured to cause movement of the one or more fans 142 across the slide such that air flow generated from the fan can be exposed or blown over different regions of the upper surface of the slide.

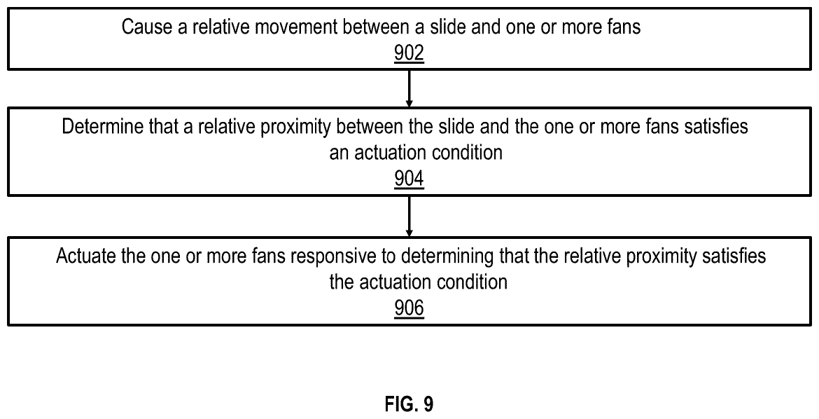

FIG. 9 shows a flow chart illustrating a method 900 for automatically mixing solutions (e.g., the stain and the buffer solution) on slides 10, according to an example embodiment of the current disclosure. The method 900 can include causing a relative movement between a slide 10 and one or more fans 142 (STEP 902), determining that a relative proximity between the slide 10 and the one or more fans 142 satisfies an actuation condition (STEP 904) and actuating the one or more fans 142 responsive to determining that the relative proximity between the slide 10 and the one or more fans 142 satisfies an actuation condition (STEP 906). The method 900 can be executed or implemented by the processor, controller and/or circuitry on the circuit board 103.

The method 900 can include causing a relative movement between a slide 10 and one or more fans 142 (STEP 902). Causing the relative movement between a slide 10 and one or more fans 142 can include causing movement of the slide 10 and or casing movement of the one or more fans 142 or both. The movement of the slide 10 can be achieved as described above in relation to the slide transport system 110. Causing movement of the position of the one or more fans can include causing movement of the one or more fans 142 142 relative to the slide 10 and other components of the staining device 100 by an actuator, e.g., similar to actuator 133 or actuator 153.

The method 900 can include determining that a relative proximity between the slide 10 and the one or more fans 142 satisfies an actuation condition (STEP 904). The relative proximity can include relative positioning of the slide 10 and the one or more fans 142 or a distance between the slide 10 and the one or more fans 142 along the predefined path. For example, the processor, controller and/or circuitry on the circuit board 103 can determine that given a distance between the stain dispensing nozzle 122 (or the stain dispensing system 120) and the one or more fans 142, the controller, processor or circuitry can determine that the distance between the slide 10 and the one or more fans 142 is equal to or less a predefined value or that the slide 10 is overlapping, at least partially, along the predefined with the one or more fans 142 as the actuation condition being satisfied. The controller, processor or circuitry can determine that the actuation condition is satisfies based on the number of angular steps that made by the motor 112 after the slide 10 is detected by sensor 124.

The method 900 can include actuating the one or more fans 142 responsive to determining that the relative proximity between the slide 10 and the one or more fans 142 satisfies an actuation condition (STEP 906). The controller, processor or circuitry can activate the one or more fans 142 for a predefined time duration. The controller, processor or circuitry may deactivate the one or more fans 142 after the predefined time duration ends.

Referring back to FIGS. 1A-3, the staining device 100 and/or the method 300 can include any of the steps or features described in this section.

### E. Washing Station or System

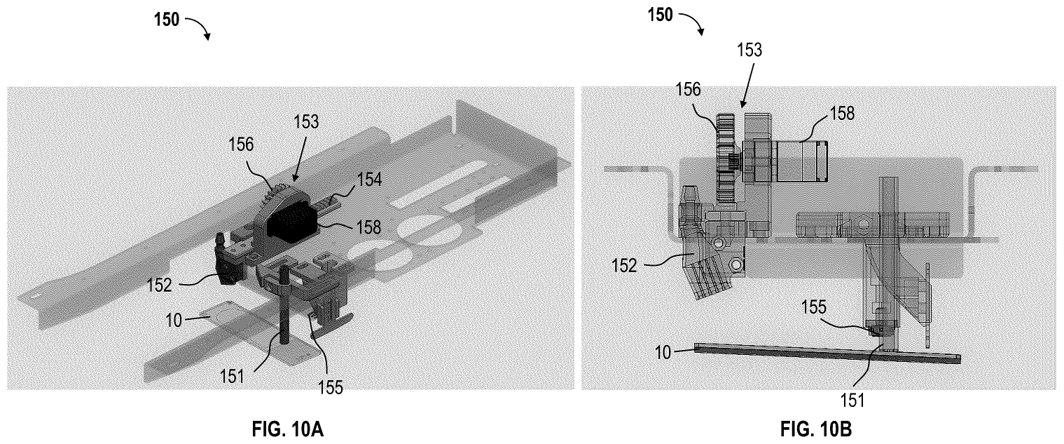

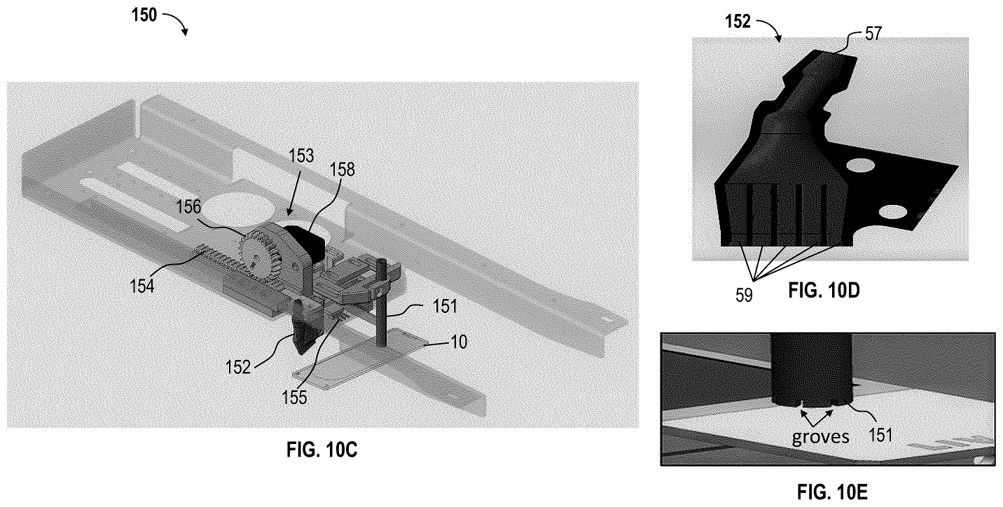

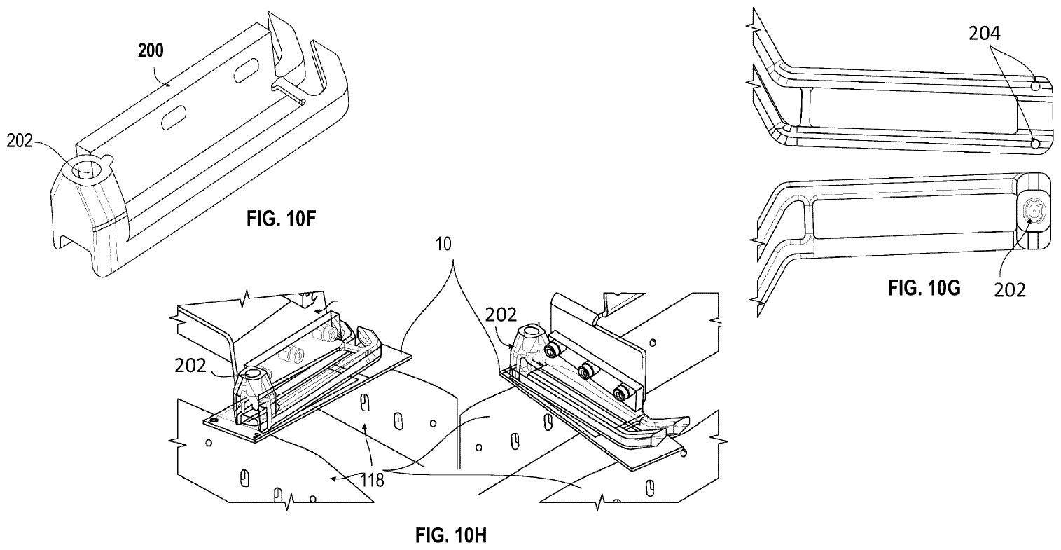

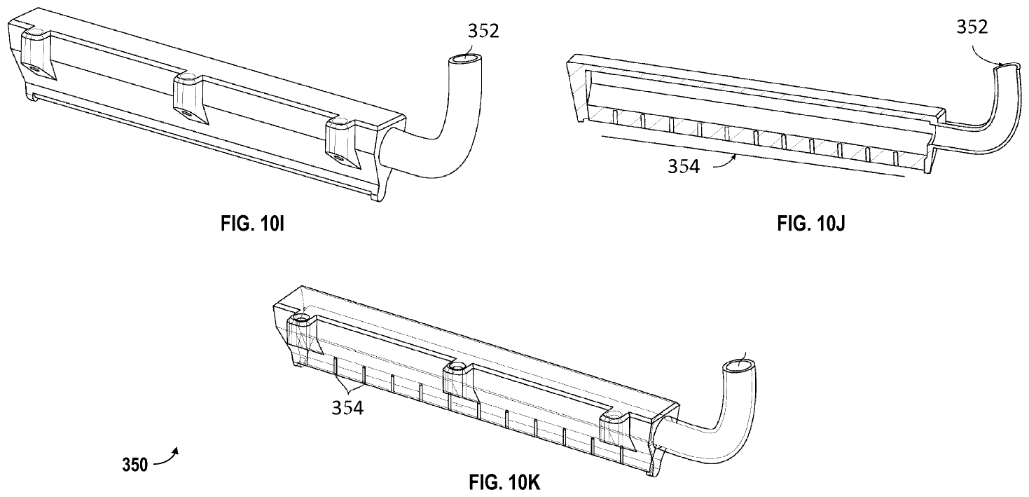

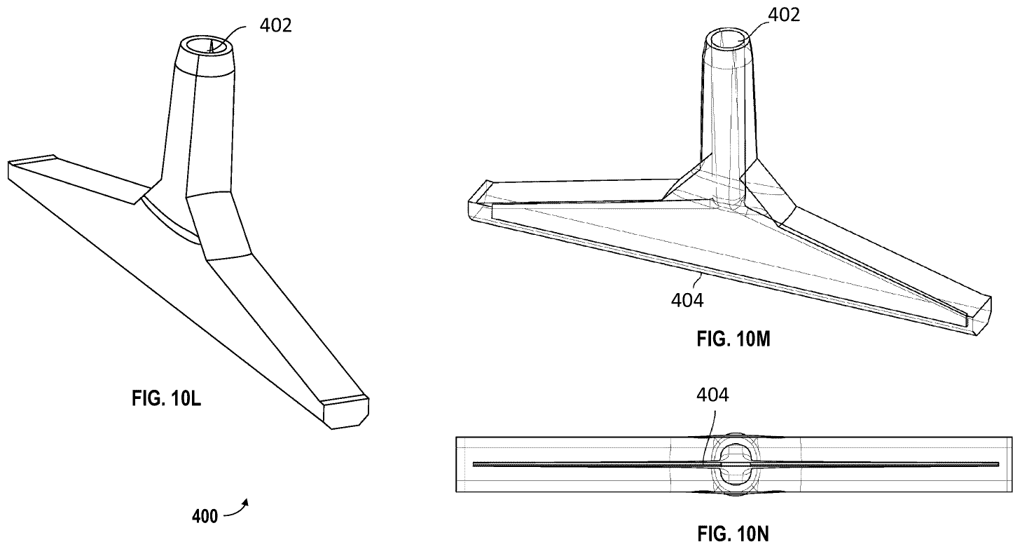

FIGS. 10A-10E depict various views of a slide washing system 150 for automatic washing of slides, according to an example embodiment of the current disclosure. In the staining process, the slides 10 are washed sometime after mixing the staining solution and the buffer solution to remove any excess of the stain, buffer solution or the mixed solution from the slide 10. The slide washing system 150 can include a washing nozzle 152 (also referred to herein as a “washing head”) arranged at a fourth position along the predefined path and configured to release or channel a buffer solution to wash the slide 10 or any excess of the stain and buffer mixture solution. The washing nozzle 152 can be arranged or arranged over the slide 10 as the slide passes by the washing nozzle 152.

The washing system 150 can include an actuator 153 configured to cause movement of the washing nozzle 152 during the washing process. In particular, the actuator 153 can cause the washing nozzle 152 to move back and forth during the washing process to cause the washing solution to flow multiple times on the slide 10. Causing the washing solution (or washing buffer) to flow over the slide 10 multiple times (or more) mimics manual washing and improves the efficiency and reliability of the washing process.

In some implementations, the actuator 153 can include a rack and pinion system. The rack and pinion system can include a rack member 154 and a gear 156 (e.g., a pinion gear). The washing nozzle 152 can be fixed, fastened or secured to the rack member 154. The rack member 154 and the gear 156 can be structured or configured such that the gear 156 engages the rack member 154. When the gear 156 rotates, it causes the rack member 154 and the nozzle 135 to exhibit a linear motion. The actuator 153 can include a motor 158, e.g., a servomotor, configured to drive rotational motion of the gear 156. The motor 158 can cause rotational motion of the gear 156 in one direction and then switch the rotational motion direction so that the rack member 154 and the washing nozzle 152 move back and forth (e.g., across a width of the slide 10).

In some implementations, the washing nozzle 152 can include an inlet (or input port) 157 and multiple, e.g., five, outlets (or output ports) 159. Having multiple outlets 159 allows the washing nozzle 152 to release the washing solution or buffer along a larger area of the upper surface of the slide 10 (e.g., compared to a single outlet 159). The washing system 150 can include a washing pump 157 configured to pump washing solution from the container 26 to be released through washing nozzle 152. The pump 157 can be a DC pump, e.g., driven by a DC motor.

The washing system 150 can include suction nozzle 151 arranged at a fifth position along the predefined path and configured or structured to remove the washing solution from the slide. The suction nozzle 151 can be positioned to contact the upper surface of the slide 10. The suction nozzle 151 can be in contact with a region of the upper surface of the slide situated between the blood smear head (blood drop position) and the label area of slide, thereby preventing the smear from being unintentionally removed or damaged by the suction nozzle. In some implementations, the suction nozzle 151 can be in contact with a region of the upper surface of the slide situated between the sample or specimen and the label area of slide to avoid damaging the sample or specimen. The suction nozzle 151 can be flexible material, e.g., forming a flexible tube. The flexibility ensures that the slide 10 can move freely without obstruction (e.g., even as the thicknesses of the slide may vary. The suction nozzle 151 can be designed to rest on the slide and apply suction to vacuum any liquid on the upper surface of the slide. Because slides 10 can have varying thicknesses, the suction nozzle 151 can be made from a flexible material such that the suction nozzle can be bent while still being able to vacuum liquid from the upper surfaces of slides of varying thicknesses.

In some implementations, the suction nozzle 151 can include one or more grooves and/or cuts at end of the suction nozzle 151 that is in contact with the slide 10. For example, the suction nozzle 151 can include multiple groves and/or distributed around the circumference of the suction nozzle 151. The grooves and/or recesses facilitate the drainage of excess stain-buffer mixture, and flowing washing solution. In other words, the fluid on the slide 10 can be pass through the grooves and/or recesses to be effectively drained through the suction nozzle 151. The grooves and/or recesses facilitate the drainage of the fluid and enable a thorough and efficient cleaning process. By removing fluid from the slide during the washing process, the suction nozzle 151 prevents or eliminates precipitates on the stained slide, which leads to clean stained slides 10 that can be analyzed more accurately under the microscope. The washing solution can include a buffer solution (similar to or different from the buffer solution used by the buffering system 130) or distilled water.

The suction nozzle 151 can be connected to a suction pump 42 configured to remove fluid from the slide 10 during the washing process and channel it to the drainage container 28. The washing system can include another drainage pump 44 configured or structure to drain fluid that falls from the slide into the staining device 100.

In some implementations, the washing system can include a sensor 155, e.g., similar to sensor 124, for detecting presence of the slide 10. Upon detecting the slide 10, the sensor 155 can generate an indication of the slide detection for the controller, processor or circuitry of the circuit board 103. In response, the controller, processor or circuitry can trigger or actuate the actuator 153 to cause movement of the washing nozzle 152 and actuate the washing pump 157 to release the washing solution through the washing nozzle 152. The controller, processor or circuitry may also trigger or actuate the suction pump 42 and/or the drainage pump 44.

FIGS. 10F-10N depict various washing nozzles (or washing heads) for washing slides, according to example embodiments of the current disclosure. The nozzles or washing heads can be referred to as channeling structures. FIGS. 10F-10H depict a first washing nozzle 200 for washing or removing excess of the mixture solution on the slide 10. The washing nozzle 200 includes one inlet port 202 and two outlet ports 204. The washing nozzle 200 can be made of a durable and corrosion-resistant material, such as stainless steel or plastic. FIGS. 101-10K depict another washing nozzle 350 for washing or removing excess of the mixture solution on the slide 10. The washing nozzle 350 includes one inlet port 352 and multiple outlet ports 354 distributed along a dimension of the washing nozzle 350. In some implementations, the outlet ports 354 may span across a dimension of the slide 10 (e.g., width or length). FIGS. 10L-10N depict yet another washing nozzle 400 for washing or removing excess of the mixture solution on the slide 10. The washing nozzle 400 includes a circular inlet port 402 and an elongated slit acting as an outlet port 404 or unit. The inlet port 402 is connected to the outlet port 404 through a channel as shown in FIG. 10M. The outlet port 404 runs almost across a dimension of the washing nozzle 400 and may cover an entire dimension of slide 10 (e.g., width or length).

In some implementations, the washing nozzle 152, 200, 350, 400 can be kept at a distance away from the slide 10 during the washing process. For example, a distance between 0.5 mm to 5 mm can be maintained between the slide 10 and the outlet port(s) of the washing nozzle.

FIG. 10O depicts the position and orientation of a slide 10 at a washing station or during the washing process, in accordance with some embodiments of the disclosure. The support members or rails 118 can have an inclined or sloped portion to cause the slide 10 to be sloped or oriented at an angle with respect to a horizontal plane when the slide 10 is being washed. The inclination helps any excess fluid on the slide 10 to move faster off the slide 10 due to gravitational force. In other words, the upper surface of slide 10 will be oriented at an angle or slopped causing fluid on the slide 10 to fall off the slide, e.g., to speed up the washing process.

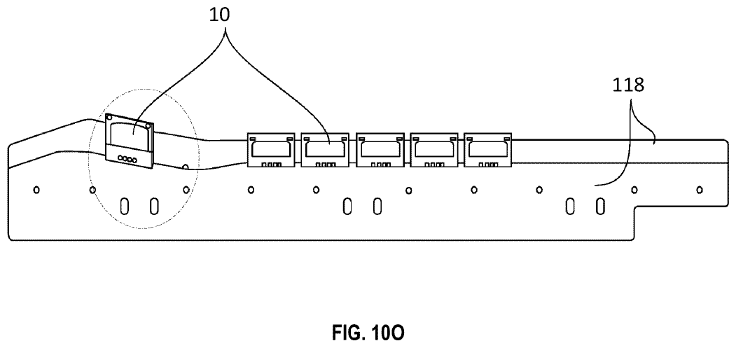

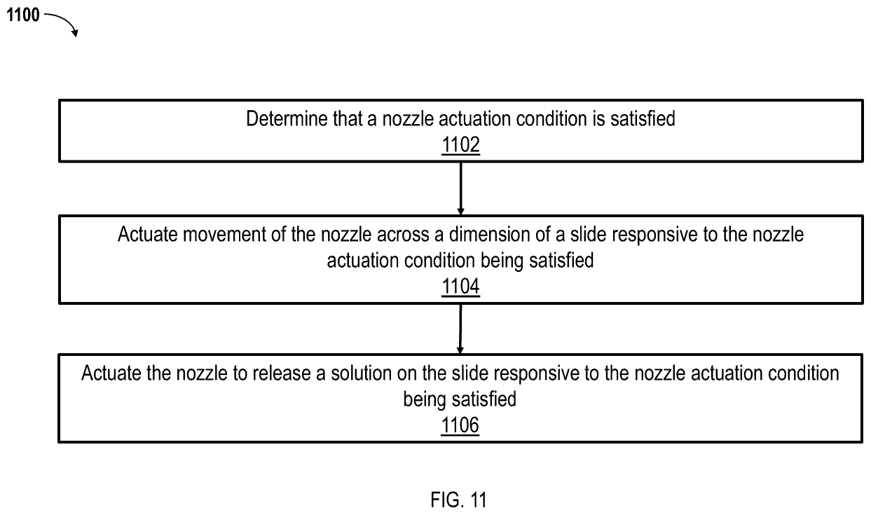

FIG. 11 is a flow chart illustrating a method 1100 of automatic washing of slides 10, according to an embodiment of the current disclosure. The method 1100 can include determining that an actuation condition of washing nozzle 152 is satisfied (STEP 1102), actuating movement of the washing nozzle 152 (STEP 1104) and actuating the washing nozzle to release washing solution on a slide (STEP 1106). The method 1100 can be executed or implemented by the processor, controller and/or circuitry on the circuit board 103.

The method 1100 can include determining that an actuation condition of washing nozzle 152 is satisfied (STEP 1102). For example, the sensor 155 can detect the slide at a predefined position associated with the washing nozzle 152 and send an indication of the detection to the processor, controller and/or circuitry on the circuit board 103. In some implementations, the processor, controller and/or circuitry can determine that the slide 10 is at predefined position associated with the washing nozzle 152 in similar way as discussed with regard to FIGS. 7 and 9.

The method 1100 can include actuating movement of the washing nozzle 152 (STEP 1104) and actuating the washing nozzle to release washing solution on a slide (STEP 1106). The method 1100 can be executed or implemented by the processor, controller and/or circuitry on the circuit board 103. In response to determining that actuation condition is satisfies, the processor, controller and/or circuitry can trigger the actuator 153 or the corresponding motor 158 to cause movement of the washing nozzle 152 and trigger or actuate the washing pump 157 to release of the washing solution on the slide 10 through the washing nozzle 152.

Referring back to FIGS. 1A-3, the staining device 100 and/or the method 300 can include any of the steps or features described in this section.

### F. Slide Wiping Station or System

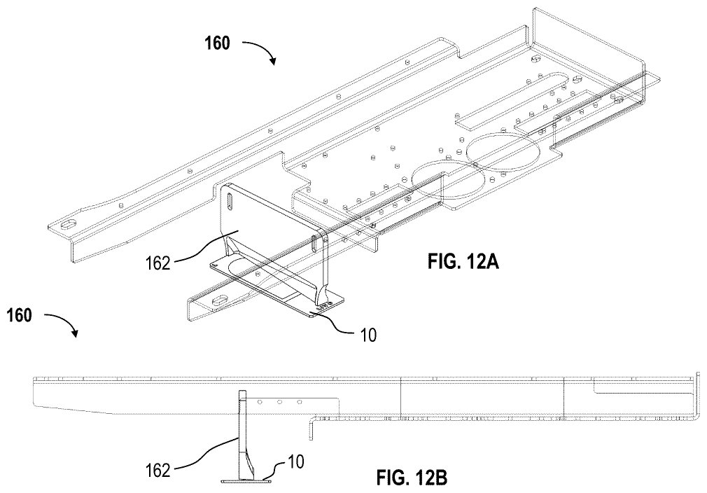

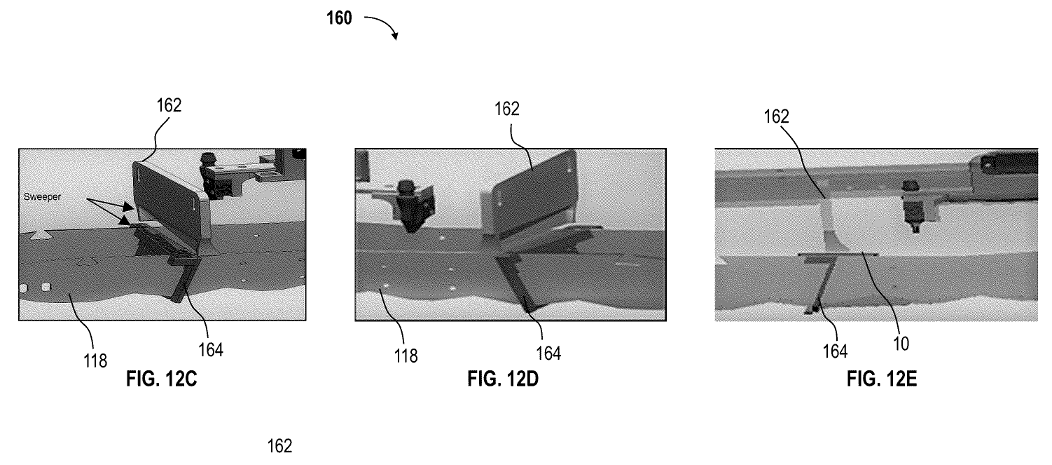

FIGS. 12A-12E depict various views of a wiping system 160 for wiping slides, according to an embodiment of the current disclosure. The wiping system 160 can include one or more sweeping members configured, structured or arranged to wipe at least one surface of the slide 10 to remove liquid on the at least one surface. FIGS. 12A and 12B depict a wiping system 160 with a sweeping member 162 positioned at a sixth position along the predefined path and configured or structured to wipe an upper surface of the slide 10. The sweeping member 162 is positioned or oriented transverse to the slide 10. When the slide 10 passes by the sweeping member 162, an edge of the sweeping member 162 comes into contact with the upper surface of the slide and wipes the upper surface of the slide 10. The sweeping member can be designed or configured to sweep the upper surfaces of slides of varying thicknesses. In some embodiments, it can do so because it is made from a flexible material. In some embodiments, the material can be the same or similar to the suction nozzle.

FIGS. 12C-12D depict a wiping system 160 with two sweeping members 162 and 164 positioned at a sixth position along the predefined path and configured or structured to wipe the upper and bottom surfaces of the slide 10. Both sweeping members 162 and 164 are positioned or oriented transverse to the slide 10. When the slide 10 moves by the wiping system 160, it passes between the sweeping member 162 and the sweeping member 154. An edge of the sweeping member 162 comes into contact with the upper surfaces of the slide 10 and an edge of the sweeping member 164 comes into contact with the bottom surface of the slide 10. As the slide 10 moves through, the sweeping member 162 wipes the upper surface of the slide 10 and the sweeping member 164 wipes the lower surface of the slide 10.

Following the washing process, residual (washing solution) liquids often remain on both on the top and bottom surfaces of the slide 10. To address this, the sweeping members 162 and 164 are strategically positioned to wipe the top and bottom surfaces, respectively. These sweeping members 162 and 164 efficiently wipe away any remaining liquid from the slides 10, effectively delivering almost dry slides to the next processing station. The sweeping members 162 and 164 can be angled (e.g., at an angle between 60 and 90 degrees relative to the slide 10) to facilitate easy removal of liquid, ensuring the slides 10 emerge with just a thin, quickly-drying layer of residual liquid.

Wiping the slide 10 causes removal of residual fluid on the surface(s) of the slide 10 and prevents or reduces precipitate build up on the slide 10. When both surfaces are wiped, the chance of precipitate build up is diminished on both surfaces leading to even cleaner slides 10.

Referring back to FIGS. 1A-3, the staining device 100 and/or the method 300 can include any of the steps or features described in this section.

### G. Slide Drying Station or System

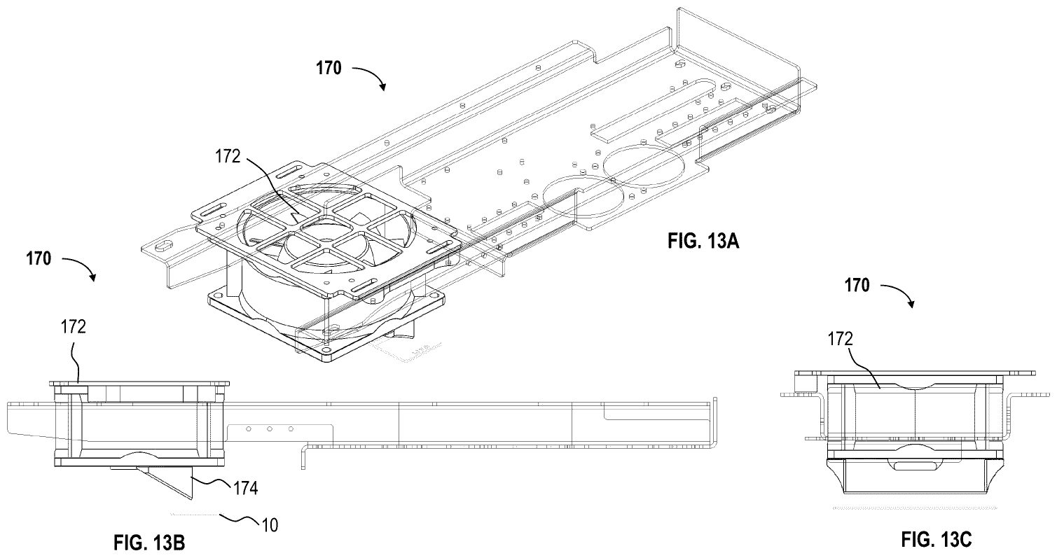

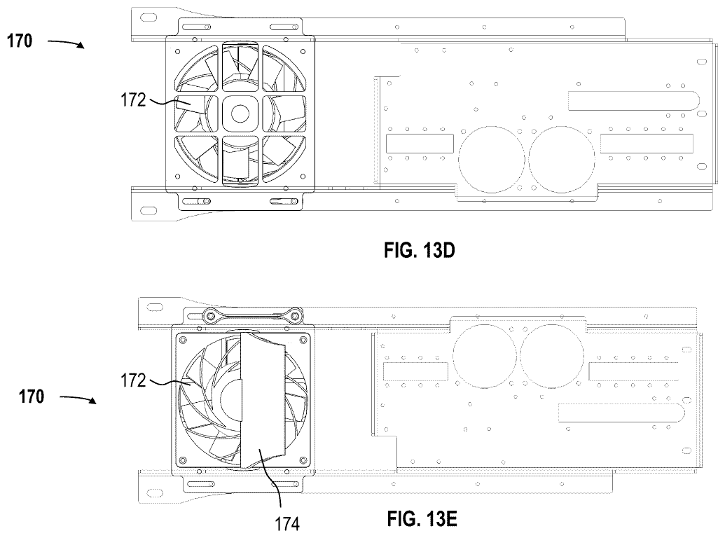

FIGS. 13A-13E depict various views of a slide drying system 170 for automatic drying of slides, according to an embodiment of the current disclosure. The slide drying system 170 can include a fan 172 configured to circulate air towards the slide 10 to cause any fluid or fluid drops left on the slide 10 to dry. In some implementations, a controller, processor or circuitry can actuate the fans 172 responsive to determining that an actuation condition is satisfied. The actuation condition can include the slide being within a predefined distance or proximity from the fan 172 or the slide 10 reaching a predefined position.

In some implementations, the slide drying system 170 may include a sensor (e.g., similar to sensor 124) positioned at a predefined location along the predefined path and configured detect the slide at the predefined location. In some implementations, the controller, processor or circuitry can determine that the slide 10 reached a predefined position or location (for the actuation condition to be satisfied) as discussed in relation with FIGS. 7 and 9. The controller, processor or circuitry can maintain the fan 172 in an on state for a predefined period of time (e.g., based on the speed of slide) and then turn off the fan 172.

In some implementations, the fan 172 can include a channel structure configured to channel the air circulated by the fan 174 along an angled direction to towards the slide 10.

### H. Slide Collection System

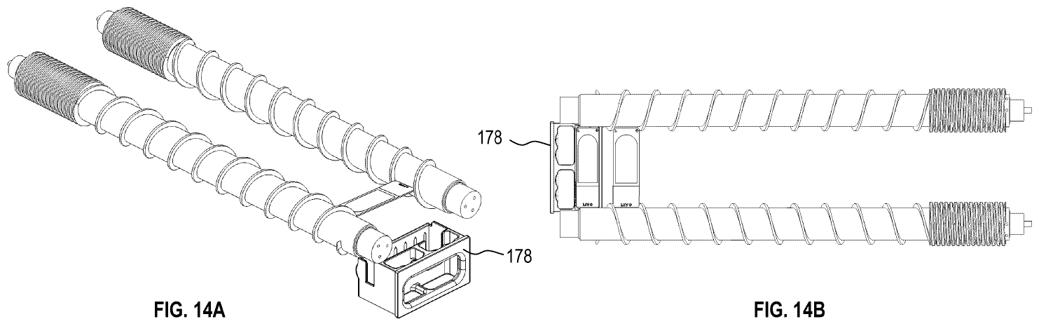

As slides 10 are output by the staining device 100 via the opening 108, different systems can be used to receive the slides 10. FIGS. 14A-14B show a collection box 178 used to receive stained or processed slides 10. The collection box 178 can be placed outside the staining device 100, e.g., beneath the opening 108. As the slides exit the staining device 100 through the opening 108, the slides 10 can fall into the collection box 178.

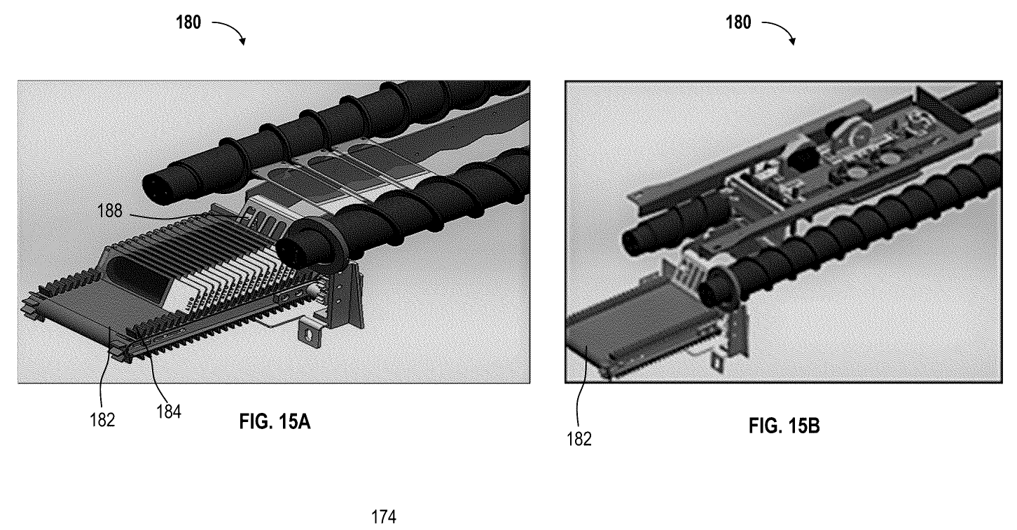

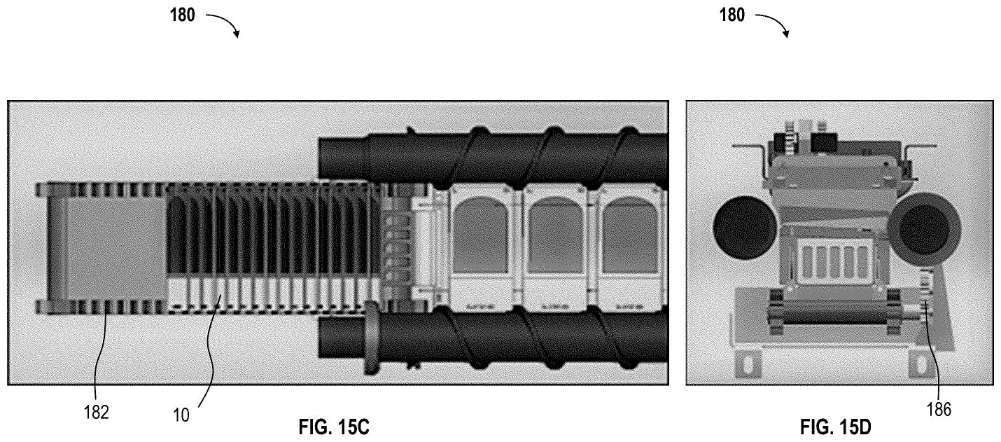

FIGS. 15A-15D depict a conveyor system 180 for receiving stained slides output by the staining device 100, according to an embodiment of the current disclosure. The conveyor system 180 can include a cleated belt 182. In some implementations, the cleated belt can include cleat elements 184 on both longitudinal end of the cleated belt 182. The cleat elements 184 can be structured, configured or arranged to form slots for receiving slides 10 at an angle as the slides drop from the member(s) 114 and/or the support members or rails 118. Consecutive cleat elements 184 on each edge of the cleated belt 182 can be spaced apart by a distance slightly larger than the thickness of the slide 10 (e.g., by about 0.2 to 0.5 millimeter) so that the spacing between a pair of consecutive cleat elements is configured to receive an edge (e.g., a longitudinal edge) of the slide 10. Also, the cleat elements 184 can be arranged to maintain a spacing between consecutive slides to mitigate the possibility of any scratching or damage to the slides 10 and/or the samples, specimens or smears placed thereon.

In some implementations, the cleat belt can be mechanically coupled to the member(s) 114 by one or more gears 186. In other words, the member(s) 114 and the cleated belt 182 can be driven or powered by the same motor 112. The gears 186 transfer motion from the member(s) 114 to the conveyor system 180 or the cleated belt 182. The mechanical coupling via the gears 186 allows for synchronized motion between the members 114 and the cleated belt 182 (or the conveyor system 180). The synchronization ensures that the slides 10 move smoothly through the entire process without any hitches.

In some implementations, the conveyor system 180 can include a sloped or inclines structure 188 configured to provide a smooth transition for the slides from the member(s) 114 and/or the support members or rails 118 to the cleated belt 182. As the cleated belt 182 rotates the slides move linearly until they are dropped off the cleated belt.

This conveyor system 180 provides technical benefits particularly in the post-staining phase of the slides 10. After the slides undergo the staining process, they are transferred to the conveyor system 180. On the conveyor system 180 or cleated belt 182, each slide is allotted a separate slot. This arrangement is designed to minimize physical contact between slides 10 preventing any potential damage. By avoiding direct contact between slides 10, the conveyor system 180 ensures that there are no scratches or other physical damages to the slides 10. This aspect allows for maintaining the quality and readability of the slides 10. Also, the design of the conveyor system 180 with individual slots allows operators easy and straightforward access to the slides 10 leading to efficiency and ease of handling during the examination or further processing of the slides. Ensuring the integrity of the smear on each slide 10 is a paramount concern.

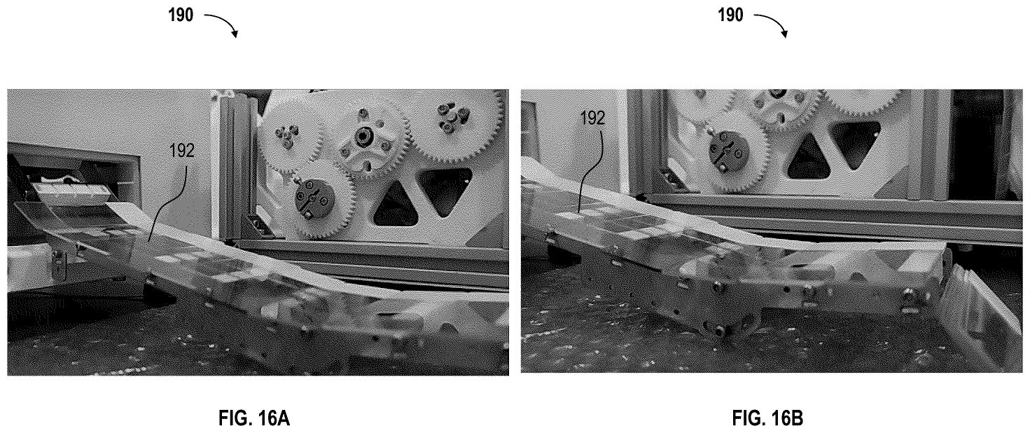

FIG. 16A-16B depict a slide transfer system 190 for receiving stained slides output by the staining device 100, according to an embodiment of the current disclosure. The slide transfer system 190 can include a sloped support structure 192 extending from the opening 108. As slides exit the opening 108, the slides 10 can slide smoothly along the sloped support structure 192 one after the other without one slide moving on top of another. The sloped support structure 192 can be designed or structured to accommodate about 10 slides or more at the same time.

As shown in FIGS. 16A-16B, the slide transfer system 190 can be configured to be positioned such that slides 10 exiting the housing of the staining device 100 can be conveyed or transferred to the slide transfer system 190. The upper surface of the slide remains exposed as it is transferred to the slide transfer system 190. As additional slides are conveyed onto the slide transfer system 190, the slides 10 on the slide transfer system 190 are pushed forward until they reach the end of the slide transfer system 190. This allows for the upper surfaces of the slides to remain exposed for longer and increase drying time of the slides. The slide transfer system can be sized to carry anywhere from 1 to 50 slides.

Both the slide transfer system 190 and the conveyor system 180 can provide more time for slides to dry out.

As shown in the various figures, including FIG. 6C, the path along which the slides are conveyed through the staining device 100 is positioned along a first plane defined in part by the members 114 (e.g., rails). One or more or all of the various systems, such as the stain dispensing system 120, the buffering system 130, the mixing system 140, the washing system 150, the wiping system 160 and the slide drying system 170 may be arranged such that components of these systems are arranged and positioned along a second plane extending along the length of the members 114 (e.g., rails) above the first plane along which the slides are transported or conveyed through the staining device 100. The distances between various components of each of the stain dispensing system 120, the buffering system 130, the mixing system 140, the washing system 150, the wiping system 160 and the slide drying system 170 relative to the upper surface of the slides transported through the stainer device can vary depending on the function, but these components are positioned at some distance above the first plane but within the region above the two members 114 (e.g., rails) of the slide transport system 110. The distance between the stain dispensing nozzle 122 and the slides resting on the members 114 (e.g., rails) can be anywhere from 1 mm to 200 mm but positioned between a first vertical plane extending through the first member 114a and a second vertical plane extending through the member 114b. The distance between the buffer dispensing nozzle 132 and the slides resting on the members 114 can be anywhere from 1 mm to 200 mm and also positioned between the first vertical plane extending through the first member 114a and the second vertical plane extending through the member 114b at a second position farther away from where the slides are placed by an operator and closer to the exit region of the staining device 100. Similarly, components of each of the mixing system 140, the washing system 150, the wiping system 160 and the slide drying system 170 can extend between the first plane and the second plane defined by the members 114a and 114b and at a distance above the upper surfaces of the slides conveyed through the staining device 100. The components of the mixing system are positioned between the components of the buffering system and the washing system, the components of the washing system 150 are positioned after the mixing system 140 but before the wiping system 160 and the components of the wiping system are positioned after the components of the washing system 150 but before the components of the slide drying system 170.

In some implementation, the staining device 100 can provide a settings menu or user interface (UI) for setting parameters of the slide staining process (or slide treatment process) by the operator. For example, when the staining device 100 is powered on, the controller, processor or circuitry of the staining device (e.g., based in input from the operator) can cause the peristaltic pump 126 to fill a tube connecting the container 22 to the stain dispensing nozzle 122 with staining solution and cause the peristaltic pump 137 to fill a tube connecting the container 24 to the buffer dispensing nozzle 132 with buffer solution. This process is referred to as priming. The operator can input various parameters, e.g., type or brand of staining solution, protocol to be used, etc., of the slide staining process (or slide treatment process) to be used by the staining device 100 to control the process.

The term “about,” as utilized herein, denotes a permissible range of variation for a numerical value. It is understood that the term “about” signifies a reasonable degree of deviation that is typical within the field of the invention, given the nature of the materials and methods used. This deviation may be expressed as a percentage of the stated value, with an exemplary range of +/−5%. For example, “about 10 cm” may be interpreted to mean a length from 9.5 cm to 10.5 cm. The exact range of deviation will be context-dependent and should be interpreted accordingly.

The term “substantially,” as utilized herein, refers to the characteristic or condition of conforming to a particular standard or feature to a great, but not necessarily complete, extent. This term is intended to encompass deviations from absolute characteristics or conditions that are minor or irrelevant to the intended functionality or performance of the disclosure. For instance, “substantially cylindrical” may include shapes that closely resemble a cylinder but may have minor variations that do not impact the functionality of the design.

The term “approximately,” as utilized herein, indicates that a given value can vary within tolerances that are acceptable for the operation or functionality of the disclosure. This variation acknowledges practical limitations in measurement and manufacturing processes. The term “approximately” implies a range of variation that is typically narrower than “about,” with a standard range often being +/−2%. For example, “approximately 50 mL” could be interpreted to mean a volume between 49 mL and 51 mL.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments herein can be practiced with modification within the spirit and scope of the claims as described herein.

What is claimed is:

1. A system for automatic staining of slides, the system comprising:
a motor;
one or more members mechanically coupled to the motor, the one or more members when actuated by the motor cause a slide including a sample placed thereon to move along a predefined path;
a first nozzle arranged at a first position along the predefined path and configured to release a staining solution on the slide;
a second nozzle arranged at a second position along the predefined path and configured to release a buffer solution on the slide; and
one or more fans arranged at a third position along the predefined path and configured to circulate air towards the slide and cause mixing of the staining solution and the buffer solution on the slide.

2. The system of claim 1, wherein a surface of the slide on which the sample is placed is facing upward.

3. The system of claim 1, wherein the one or more members include one or more rods, each rod including a protruding helical structure configured to engage the slide and cause the slide to move along the predefined path.

4. The system of claim 3, wherein each rod includes a male thread at one end, a groove of the male thread structured to receive the slide.

5. The system of claim 1, comprising one or more support elements extending along the predefined path to support the slide along the predefined path.

6. The system of claim 1, further comprising an actuator configured to adjust a distance between the first nozzle and the second nozzle along the predefined path.

7. The system of claim 6, wherein the actuator includes a rack and pinion system mechanically coupled to the second nozzle and configured to cause displacement of the second nozzle to adjust the distance between the first nozzle and the second nozzle along the predefined path.

8. The system of claim 1, further comprising a channel structure having one or more outlets and configured to channel air circulated by the one or more fans, via the one or more outlets, towards the staining solution and the buffer solution on the slide.

9. The system of claim 1, further comprising:
one or more sensors configured to detect that a proximity between the slide and at least one of the first nozzle, the second nozzle or the one or more fans satisfies a predefined condition; and
an actuator configured to actuate at least one of the first nozzle, the second nozzle or the one or more fans responsive to detecting that the proximity satisfies the predefined condition.

10. The system of claim 1, further comprising a third nozzle arranged at a fourth position along the predefined path and configured to release a washing solution on the slide, wherein the slide is sloped along a portion of the predefined path associated with the third nozzle.

11. The system of claim 10, further comprising an actuator configured to move the third nozzle across a dimension of the slide while the third nozzle is releasing the washing solution on the slide.

12. The system of claim 10, further comprising a suction nozzle arranged at a fifth position along the predefined path and configured to remove the washing solution from the slide.

13. The system of claim 1, further comprising one or more sweeping members arranged to wipe at least one surface of the slide to remove liquid on the at least one surface.

14. The system of claim 1, further comprising at least one second fan placed at a fourth position along the predefined path and configured to circulate air to dry liquid on the slide.

15. The system of claim 1, further comprising a housing including an opening.

16. The system of claim 15, further comprising a slide transfer structure having a first end coupled to the opening and configured to receive the slide from the opening, the slide transfer structure having a second end and configured to accommodate a plurality of slides between the first end and the second end.

17. The system of claim 16, further comprising a cleated belt conveyor configured to receive the slide from the opening, the cleated belt conveyor including a plurality of slots to accommodate a plurality of slides, wherein the cleated belt conveyor is mechanically coupled to the one or more members through one or more gears.

18. The system of claim 17, further comprising a container configured to receive the slide from the opening.

19. A method for automatic staining of slides, the method comprising:
causing, by a first motion actuator, movement of a slide including a sample placed thereon along a predefined path;
automatically actuating a first nozzle arranged at a first position along the predefined path to release a staining solution on the slide responsive to determining that a first actuation condition is satisfied;
actuating a second nozzle arranged at a second position along the predefined path to release a buffer solution on the slide responsive to determining that a second actuation condition is satisfied; and
actuating, responsive to determining that a third actuation condition is satisfied, one or more fans arranged at a third position along the predefined path to circulate air towards the slide and cause mixing of the staining solution and the buffer solution on the slide.

20. A system, comprising:
one or more support elements structured to support a slide containing a sample placed thereon;
one or more fans; and
a motion actuator coupled to either the slide or the one or more fans and configured to cause relative movement between the slide and the one or more fans, the one or more fans configured to circulate air to spread at least one solution on the slide responsive to the relative movement between the slide and the one or more fans.
